(19) United States
(12) Patent Application Publication
(10) Pub. No.: US 2014/0095246 A1
(43) Pub. Date: Apr. 3, 2014

(54) SUPPLY CHAIN FINANCIAL ORCHESTRATION SYSTEM THAT ORCHESTRATES SUPPLY CHAIN EVENTS

(71) Applicant: Oracle International Corporation, Redwood Shores, CA (US)

(72) Inventors: Karthik NATARAJAN, Bangalore (IN); Shyam Sundar SANTHANAM, Redwood City, CA (US); Amit Ranjan KUMAR, Hyderabad (IN); Girish JHA, Hyderabad (IN)

(73) Assignee: Oracle International Corporation, Redwood Shores, CA (US)

(21) Appl. No.: 14/032,268

(22) Filed: Sep. 20, 2013

Related U.S. Application Data
(60) Provisional application No. 61/707,630, filed on Sep. 28, 2012.

(51) Int. Cl. G06Q 10/06

(52) U.S. Cl. CPC G06Q 10/06315
USPC 705/7.25

(57) ABSTRACT

A system is provided that orchestrates a supply chain event. The system receives a supply chain event from an external source system. The system further retrieves a source document referenced by the supply chain event. The system further retrieves a supply chain financial orchestration flow assigned to the source document, where the supply chain financial orchestration flow defines a trade relationship between a first entity and a second entity. The system further selects one or more tasks defined for the supply chain financial orchestration flow. The system further initiates execution of the one or more tasks, where each task is executed at an external target system.

### CROSS-REFERENCE TO RELATED APPLICATIONS

This application claims priority of U.S. Provisional Patent Application Ser. No. 61/707,630, filed on Sep. 28, 2012, the subject matter of which is hereby incorporated by reference.

### FIELD

One embodiment is directed to a computer system, and more particularly, to a computer system that orchestrates supply chain financial processes.

### BACKGROUND

As the world economy becomes more integrated, company supply chains inherently become more international and complex. As a result, companies often look to less traditional ways to gain supply chain efficiencies. Reducing labor cost, transportation cost, and inventory cost, as well as improving customer service, are always a priority. However, optimizing a financial flow of goods across international markets is an area where companies have significant financial and taxation benefits.

One of the common ways to optimize or reduce costs when distributing goods internationally is to establish a legal entity in a lower tax jurisdiction to centrally buy and sell goods to move them through the supply chain in a tax-efficient manner to the end customer. However, the geographic location of the legal entity often does not fit in the optimal physical flow. The financial flow of the goods typically deviates from the physical flow. While the financial benefit can be significant, enabling this type of distribution model can be challenging due to the increased complexity companies are required to manage.

When distributing goods internationally, companies are careful to consider their operating structure and strategy for physical flow of goods as equally important as the financial flow. A common approach to managing the distribution of goods across multiple companies spread out in different countries is through a principal company, which is established in a lower tax jurisdiction. The structuring of the relationship and terms between the principal company and the local selling companies takes into account a level of added value performed by each party and levels of risk assumed by each party.

Beyond tax savings, companies often look to gain operational efficiencies through centralizing key business functions at the principal company. Some of these types of business functions include: (a) sourcing and procurement—a multi-national company can gain operational efficiencies by centralizing sourcing and procurement and potentially reducing overall spending; (b) customer service—centralizing customer service can help achieve economies of scale while making it easier to present a single face to the customer; (c) demand and production planning—because the principal company is often the main distribution intermediary, it is in a good position to forecast demand and production requirements at an aggregate level; and (d) back office accounting—centralizing accounting functions such as accounts payable and receivables can lower transaction costs and create opportunities for outsourcing.

### SUMMARY

One embodiment is a system that orchestrates a supply chain event. The system receives a supply chain event from an external source system. The system further retrieves a source document referenced by the supply chain event. The system further retrieves a supply chain financial orchestration flow assigned to the source document, where the supply chain financial orchestration flow defines a trade relationship between a first entity and a second entity. The system further selects one or more tasks defined for the supply chain financial orchestration flow. The system further initiates execution of the one or more tasks, where each task is executed at an external target system.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates an example supply chain financial orchestration flow, according to an embodiment of the invention.

FIG. 3 illustrates a block diagram of an example architecture of a supply chain financial orchestration system, according to an embodiment of the invention.

FIG. 4 illustrates an example enterprise structure, according to an embodiment of the invention.

FIG. 5 illustrates a flow diagram of the functionality of a supply chain financial orchestration flow module, according to an embodiment of the invention.

FIG. 6 illustrates an example user interface for defining a documentation and accounting rule, according to an embodiment of the invention.

FIG. 7 illustrates an example user interface for defining a transfer pricing rule, according to an embodiment of the invention.

FIG. 8 illustrates an example user interface for defining an agreement, according to an embodiment of the invention.

FIG. 9 illustrates another example user interface for defining an agreement, according to another embodiment of the invention.

FIG. 10 illustrates an example user interface for defining a qualifier, according to an embodiment of the invention.

FIG. 11A illustrates a portion of an example user interface for defining a supply chain financial orchestration flow, according to an embodiment of the invention.

FIG. 11B illustrates another portion of an example user interface for defining a supply chain financial orchestration flow, according to an embodiment of the invention.

FIG. 12 illustrates a flow diagram of the functionality of a supply chain financial orchestration flow module, according to another embodiment of the invention.

FIG. 13 illustrates an example user interface for managing supply chain event exceptions, according to an embodiment of the invention.

FIG. 14 illustrates a portion of an example user interface for managing supply chain event exceptions, where the portion can display a supply chain event exception message, according to an embodiment of the invention.

FIG. 15 illustrates a portion of an example user interface for managing supply chain event exceptions, where the portion can submit supply chain events for re-processing, according to an embodiment of the invention.

FIG. 16 illustrates an example user interface for confirming an assignment of a supply chain financial orchestration flow, according to an embodiment of the invention.

FIG. 17 illustrates an example user interface for monitoring an execution of a supply chain financial orchestration flow, according to an embodiment of the invention.

FIG. 18 illustrates a portion of an example user interface for monitoring an execution of a supply chain financial orchestration flow, where the portion can display details of a monitored supply chain financial orchestration flow, according to an embodiment of the invention.

FIG. 19 illustrates a portion of an example user interface for monitoring an execution of a supply chain financial orchestration flow, where the portion can display one or more exception messages for a monitored supply chain financial orchestration flow, according to an embodiment of the invention.

FIG. 20 illustrates a portion of an example user interface for monitoring an execution of a supply chain financial orchestration flow, where the portion can perform a recover action for a supply chain financial orchestration flow, according to an embodiment of the invention.

### DETAILED DESCRIPTION

According to an embodiment, a supply chain financial orchestration system is provided that can provide an infrastructure and framework to define supply chain financial orchestration flows, where a supply chain financial orchestration flow defines a trade relationship between a first entity and a second entity. In defining supply chain financial orchestration flows, the supply chain financial orchestration system can manage the internal trade relationships between the first entity and the second entity (where the first entity and the second entity may belong to a large enterprise that can be spread across geographies), by defining the nature of trade relationships, business rules, internal controls, regulatory compliances, and other terms and conditions that can be used to execute, monitor and evaluate transactions emanating out of such trade relationships. The supply chain financial orchestration system can further orchestrate supply chain events that arise out of a transaction associated with the supply chain financial orchestration flow and that are received from external source systems. Through orchestrating the supply chain events, the supply chain financial orchestration system can initiate the execution of tasks associated with the supply chain financial orchestration flow, where the tasks can be executed at external target systems. Thus, given a transaction that involves a specific movement of goods within the supply chain financial orchestration flow, the supply chain financial orchestration system can generate a series of financial movement of goods that can give equitable distribution of the product margin to countries and tax jurisdictions involved in the transaction.

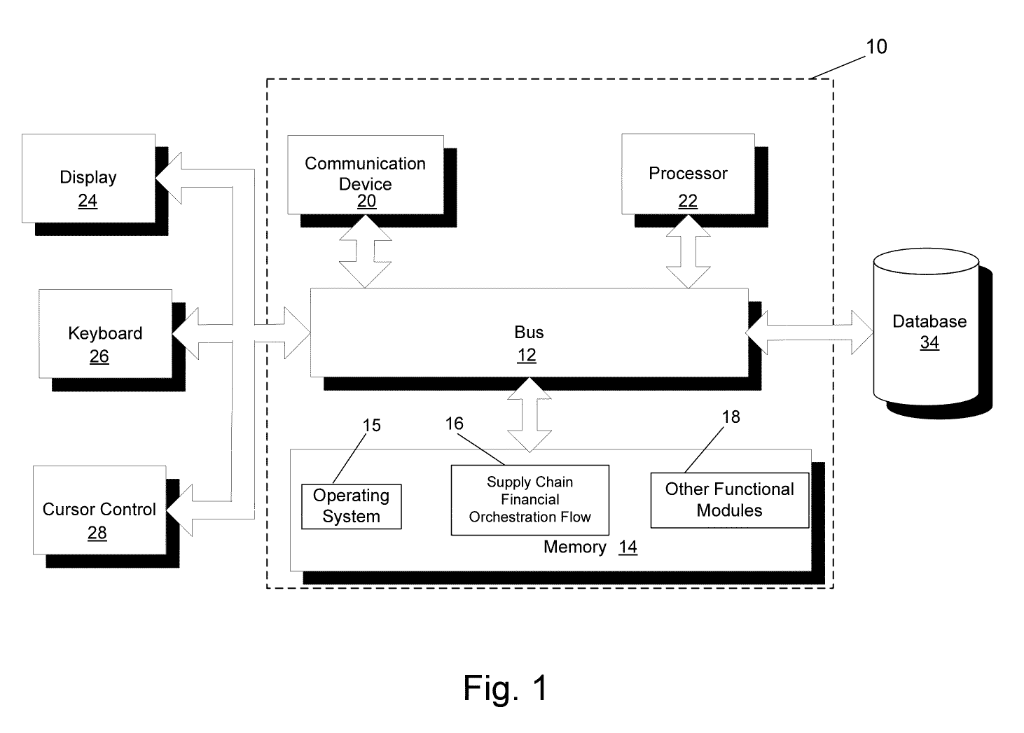

FIG. 1 illustrates a block diagram of a supply chain financial orchestration system 10 that may implement one embodiment of the invention. Supply chain financial orchestration system 10 includes a bus 12 or other communications mechanism for communicating information between components of supply chain financial orchestration system 10. Supply chain financial orchestration system 10 also includes a processor 22, operatively coupled to bus 12, for processing information and executing instructions or operations. Processor 22 may be any type of general or specific purpose processor. Supply chain financial orchestration system 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. Supply chain financial orchestration system 10 further includes a communication device 20, such as a network interface card or other communications interface, to provide access to a network. As a result, a user may interface with supply chain financial orchestration system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with supply chain financial orchestration system 10.

According to one embodiment, memory 14 can store software modules that may provide functionality when executed by processor 22. The modules can include an operating system 15, a supply chain financial orchestration flow module 16, as well as other functional modules 18. Operating system 15 can provide an operating system functionality for supply chain financial orchestration system 10. Supply chain financial orchestration flow module 16 can provide functionality for orchestrating a supply chain event, as is described in more detail below. In certain embodiments, supply chain financial orchestration flow module 16 can comprise a plurality of modules that each provide specific individual functionality orchestrating a supply chain event. Supply chain financial orchestration system 10 can also be part of a larger system. Thus, supply chain financial orchestration system 10 can include one or more additional functional modules 18 to include the additional functionality. For example, functional modules 18 may include modules that provide additional functionality, such as one or more “Oracle Fusion Applications” from Oracle Corporation. In another example, functional modules 18 may include enterprise resource planning (“ERP”) modules of an ERP system, where an ERP system is a computer system that integrates several data sources and processes of an organization into a unified system.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

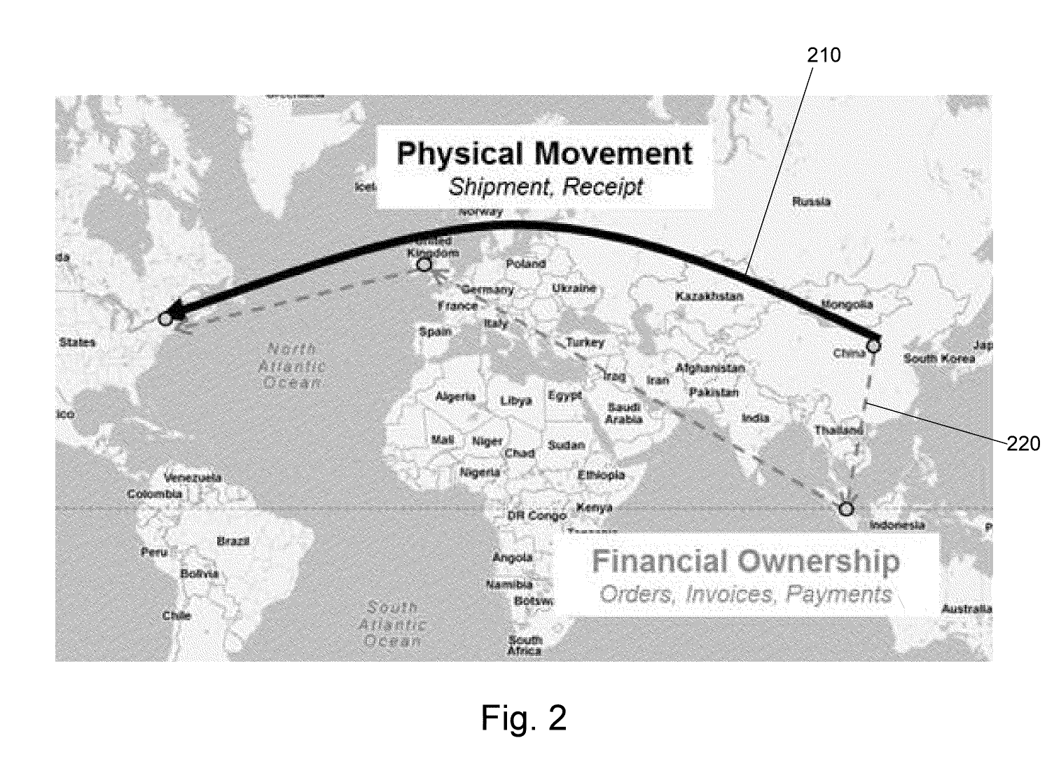

FIG. 2 illustrates an example supply chain financial orchestration flow, according to an embodiment of the invention. The supply chain financial orchestration flow is between a shipping entity in China and a receiving entity in the United States. As illustrated in FIG. 2, the supply chain financial orchestration flow includes a physical movement flow 210 and a financial flow 220. Physical movement flow 210 represents the physical movement of items from the shipping entity in China, to the receiving entity in the United States, and can involve the physical movement through one or more intermediate entities. Physical movement flow 210 can include one or more physical transactions that are executed in association with the physical movement of the items (such as shipments, receipts, etc.). Financial flow 220 represents the change in financial ownership of items from the shipping entity in China, to the receiving entity in the United States, and can involve the change in financial ownership of one or more intermediate entities. Financial flow 220 can include one or more financial transactions that are executed in associate with the change in financial ownership of the items (such as orders, invoices, payments, etc.). As illustrated in FIG. 2, a physical movement flow can be separate and independent of a financial flow within a supply chain financial orchestration system.

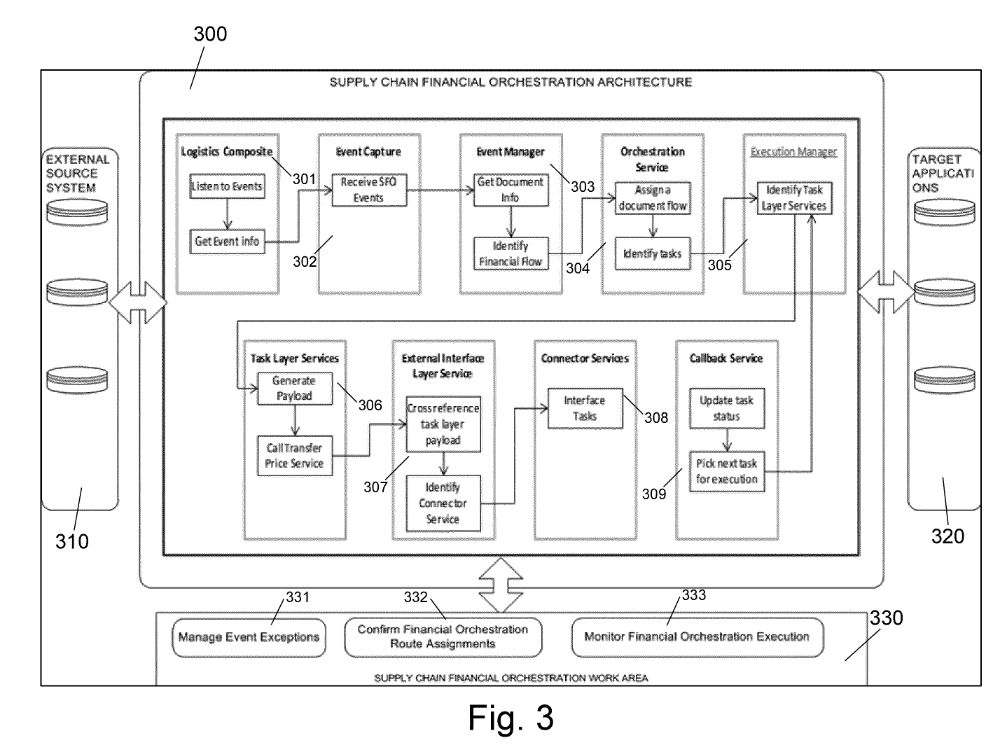

FIG. 3 illustrates a block diagram of an example architecture of a supply chain financial orchestration system 300, according to an embodiment of the invention. According to the embodiment, supply chain financial orchestration system 300 is a configurable system that manages internal trade relationships between entities belonging to an enterprise, where the enterprise is typically spread across geographies. Supply chain financial orchestration system 300 can define a nature of trade relationships, business rules, internal controls, regulatory compliances, and other terms and conditions required to execute, monitor, and evaluate trade transactions emanating out of such relationships. More specifically, supply chain financial orchestration system 300 can listen to events that occur in supply chain transactions in various external source systems, and can identify internal transactions (such as inter-company transactions and intra-company transactions) based on pre-defined trade relationships. Once the internal transactions are identified, supply chain financial orchestration system 300 can create necessary accounting and documentations required to be generated for the internal transactions according to the business rules defined in supply chain financial orchestration system 300.

According to the illustrated embodiment, supply chain financial orchestration system 300 includes event mediator 301, event capture 302, event manager 303, orchestration service 304, execution manager 305, task layer service 306, external interface layer service 307, connector service 308, and callback service 309. Event mediator 301 listens for events generated by an external source system (i.e., application) of external source systems (i.e., applications) 310. If an event is of interest to supply chain financial orchestration system 300, event mediator 301 can also call a web service exposed by the external source system of external source systems 310 to enrich the event details. Event mediator 301 then sends the event to event capture 302. Event capture 302 validates the event details retrieved after enrichment, and stores the event in an external source system format.

Subsequently, event manager 303 identifies a source document enrichment web service based on a source order type, and calls the source document enrichment web service for enrichment. The source document enrichment service is exposed by an external source system of external source systems 310 where the source order originated. Event manager 303 can pass a source document identifier as an input parameter to the enrichment web service and can retrieve the source document information, where a source document identifier is a unique identifier of the source document that is communicated to the external system of external source systems 310. The external source system of external source systems 310 that is responsible for capturing the physical transaction can be responsible for passing the source document identifier as part of event information. Supply chain financial orchestration system 300 can maintain an association between a supply chain event and a source document type. Event manager 303 can further transform the source document information into a format that is understandable by supply chain financial orchestration system 300, and can identify a supply chain financial orchestration flow based on qualifiers, source document type, physical route, parties involved in an internal trade, and a priority of the supply chain financial orchestration flow. Further, a supply chain financial orchestration flow can be date effective. This means that any modification to a supply chain financial orchestration flow can cause a new effective date to be associated with the supply chain financial orchestration flow. Thus, transactions pertaining to a source document created before the effective date of the modification can be associated with the original supply chain financial orchestration flow, and transactions pertaining to a source document created after the effective date of the modification can be associated with the modified supply chain financial orchestration flow.

Orchestration service 304 verifies whether a supply chain financial orchestration flow is already assigned to a source document or not. If the supply chain financial orchestration flow is not already assigned, orchestration service 304 can assign the supply chain financial orchestration flow to the source document, and can generate the tasks that are to be performed between internal entities based on the documentation and accounting rules setup for the supply chain financial orchestration flow (such as a global procurement flow, a customer shipment flow, and an internal transfer flow). A global procurement flow is a supply chain financial orchestration flow where a central buying entity buys goods from suppliers on behalf of one or more internal entities. The supplier liability is borne by the purchasing entity. The purchasing and requesting entity settle the transaction among themselves using a transfer price (sometimes through one or more intermediary entities). A customer shipment flow is a supply chain financial orchestration flow in which a selling business unit is different from a profit center business unit of the entity that owns and ships the goods. The selling entity receives an order from a customer, and the shipping entity ships the goods directly to the customer. The shipping entity is settled financially by the selling entity (sometimes through one or more intermediary entities). A customer shipment flow can be an internal drop shipment flow, which is a forward customer shipment flow, or a customer drop shipment flow, or a return customer shipment flow. An internal transfer flow is a supply chain financial orchestration flow in which physical movement of goods happens between internal entities. The internal entities settle the financial transactions among themselves using a transfer price.

The tasks that are to be performed can be specific to a forward flow and a return flow for the supply chain financial orchestration flow. A forward flow is a flow of events that proceeds in a specific direction (such as from a supplier entity to a purchaser entity), and a return flow is a flow of events that proceeds in a reverse direction (such as from a purchaser entity to a supplier entity). In addition to ownership transfer between internal entities, events indicating ownership transfer from a supplier entity to a purchasing entity can also be setup in a supply chain financial orchestration flow definition. When an event designated as a supplier ownership change event occurs, orchestration service 304 can generate the tasks for creating trade distributions to book supplier accrual and costs in a costing system, as well. Execution manager 305 invokes a task layer service based on a task type. Generally, the tasks are performed in a defined sequence, and if there is any dependency from a previous task, execution manager 305 can wait for the previous task to complete. Example task types can include inter-company trade documents (e.g., purchase order and sales order), trade distribution tasks related to costing, inter-company receivable invoices related to inter-company receivable, payables invoice, or credit memo tasks that are set in documentation and accounting rules. Task types can also include user-defined tasks.

Task layer service 306 creates a task layer service payload. Task layer service 306 can include logic to populate the payload data depending on a global procurement flow, a customer shipment flow, or an internal transfer flow. Task layer service 306 can also call a transfer price service to get a transfer price, where the transfer price is a price in which a selling entity sells goods to a purchasing entity, where the selling entity and the purchasing entity are involved in an internal trade. External interface layer service 307 identifies a target system (i.e., application) of target systems (i.e., applications) 320, and obtains a connector service (e.g., connector service 308) for the target system of target systems 320 based on the task type. Connector service 308 transforms the task layer service payload into a format which is understandable by the target system of target systems 320. Once the task data is transformed according to a target system format, connector service 308 calls a web service to interface tasks in interface tables of the target system of target systems 320. Callback service 309 receives responses from the target system of target systems 320 and updates the task status. If the task is a last task in a sequence, then the supply chain financial orchestration is complete. Otherwise, the next task in the sequence is selected, and execution manager 305 is invoked with the task type.

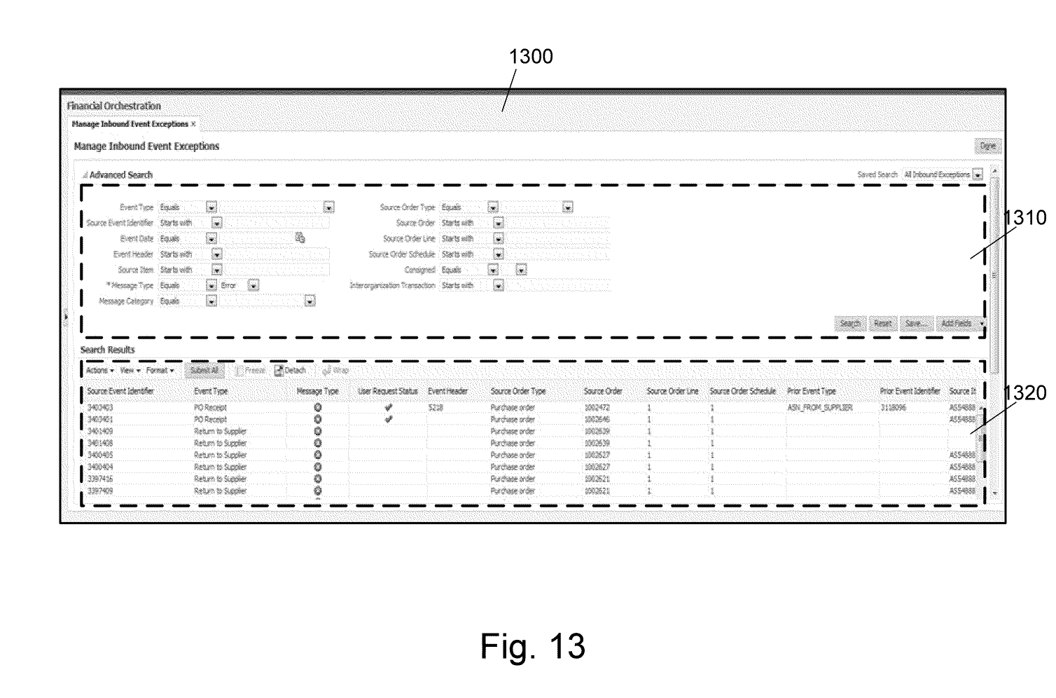

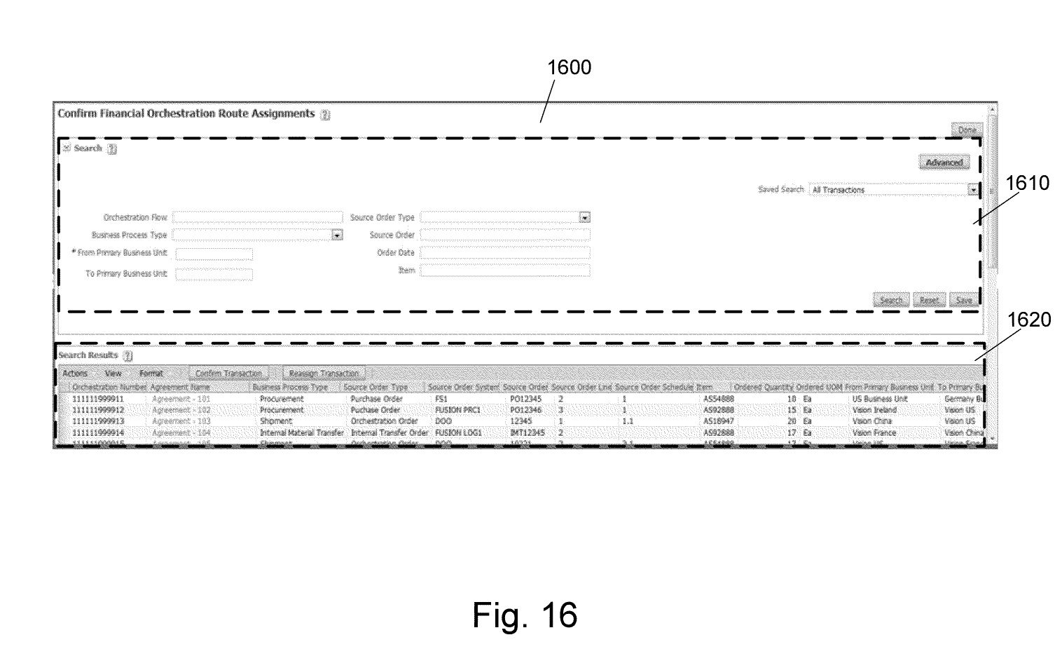

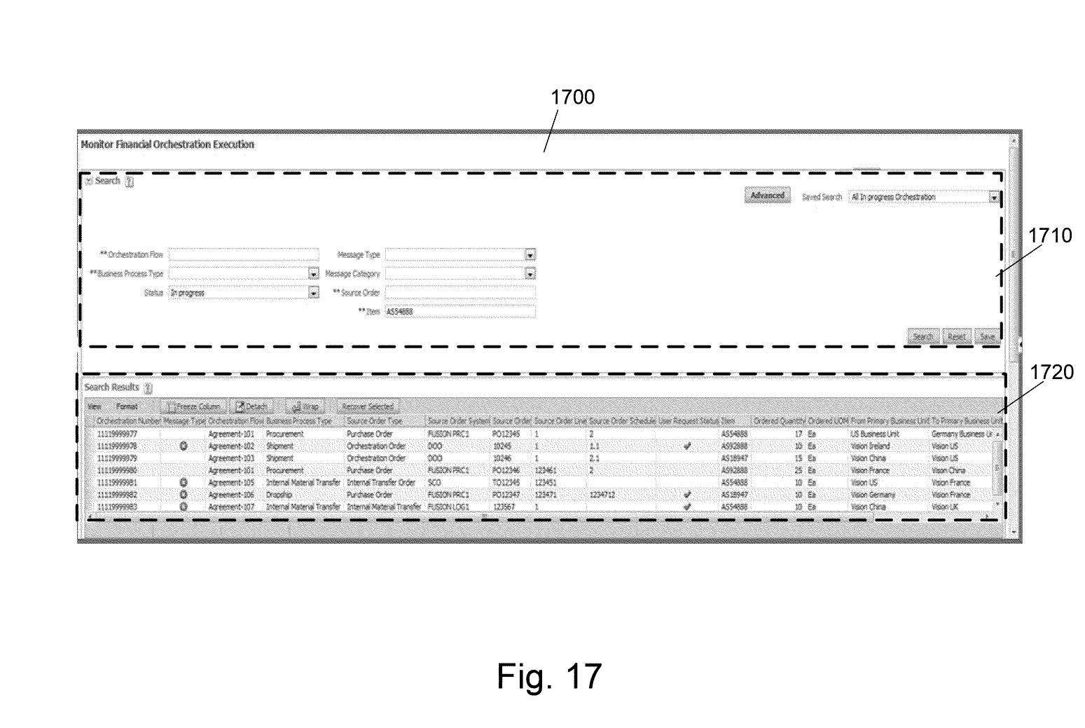

Supply chain financial orchestration system 300 further includes a supply chain financial orchestration work area 330 that includes a plurality of user interfaces that allow a user to interact with supply chain financial orchestration system 300. Supply chain financial orchestration work area 330 includes manage event exceptions 331, confirm financial orchestration route assignments 332, and monitor financial orchestration execution 333. Manage event exceptions 331 is a user interface that allows users to view, troubleshoot, and manage events which faulted due to a setup or technical reason. Manage event exceptions 331 is further described below in greater detail in conjunction with FIGS. 13, 14, and 15. Confirm financial orchestration route assignments 332 is a user interface that allows a user to confirm a supply chain financial orchestration flow before the tasks of the supply chain financial orchestration flow are initiated by orchestration service 304. Confirm financial orchestration route assignments 332 is further described below in greater detail in conjunction with FIG. 16. Monitor financial orchestration execution 333 is a user interface that allows user to monitor supply chain financial orchestration flows that are in progress, that have not started, and that have completed. Monitor financial orchestration execution 333 is further described below in greater detail in conjunction with FIGS. 17, 18, 19, and 20.

In one embodiment, a supply chain financial orchestration system can have the capability of defining rules for a financial route selection by providing a qualifier rule. The qualifier rule can be evaluated, and can provide a highest priority financial route for the supply chain financial orchestration system. More specifically, an agreement that is defined by a user can define a financial route along with one or more buy/sell terms, one or more pricing rules, and/or one or more documentation and accounting rules to be used for an internal transactions. A user may wish to identify a suitable agreement based on different business parameters, such as supplier, item category, entity, etc. For example, a user may wish to use “Agreement A” for item category “Electronics” and “Agreement B” for item category “Machinery.” Thus, these business parameters can act as qualifiers for agreement identification. According to the embodiment, a qualifier rule can be defined and attached to an agreement. During an execution of a supply chain financial orchestration flow, one or more agreements that are defined for a pair of buying and selling entities of a transaction can be identified, and the one or more qualifier rules attached to the one or more identified agreements can be evaluated, and the appropriate agreement to be used for the transaction can be identified and selected. Without qualifier rules, it can be very difficult to identify an agreement for different combinations of business parameters, and it could require the customization of the source code, including “hard-coding” the agreement usage for different set of business parameters. Qualifier rules can make the process of associating an agreement with a supply chain financial orchestration flow easier.

Additionally, in one embodiment, a supply chain financial orchestration system can orchestrate tasks of a supply chain financial orchestration flow based on a defined date effective setup (i.e., a defined effective start date and a defined effective end date). More specifically, different objects (such as transfer pricing rules or tasks) can be defined in a date effective manner (i.e., defined with an effective start date and an effective end date) within an agreement. A modification to the object (e.g., transfer pricing rule or task) can be made independently for any particular date range without affecting the other objects. Once setup data is identified for a source document, the same setup data can be used for the events arising for that source document, irrespective of the changes made to the setup data after the first event arrival.

For example, when a trigger event arises, an appropriate agreement and tasks for the agreement can be identified for a specified date associated with the event within a table, as shown below:

| Task Name | Effective Start Date | Effective End Date |
|---|---|---|
| T1 | 01-Jan-2010 | 31-Dec-2012 |
| T2 | 01-Jan-2010 | 31-Dec-2012 |
| T3 | 01-Jan-2010 | 31-Dec-2012 |

In the example, an event can be received with a date of “01-Feb-2010” for a purchase order document, “PO111.” The tasks to be performed are tasks T1, T2, and T3. As shown above, one or more entries can be made in the table for a source document, and the effective date can be used for identifying the tasks. The effective date can then be used to identify the tasks when further events are triggered for that source document. This can ensure that when a setup is changed, future events for the source document will use the already-identified effective date, select the tasks corresponding to the appropriate date range that includes the effective date, and orchestrate the tasks.

In the above example, if an entity needs to additionally perform task T0 for new purchase order documents created in 2011 and onwards, but continue to only perform tasks T1, T2, and T3 for older purchase order documents created in 2010 or earlier, the table can be modified as follows:

| Task Name | Effective Start Date | Effective End Date |
|---|---|---|
| T0 | 01-Jan-2011 | 31-Dec-2012 |
| T1 | 01-Jan-2010 | 31-Dec-2012 |
| T2 | 01-Jan-2010 | 31-Dec-2012 |
| T3 | 01-Jan-2010 | 31-Dec-2012 |

When another event is received for the purchase order document, “PO111,” on Feb. 1, 2011, the supply chain financial orchestration system can refer to the previous entry that was made for the purchase order document, “PO111,” select the effective date as “01-Feb-2010,” and only perform the tasks T1, T2, and T3. If an event is received for a new purchase order document, “PO222,” on Feb. 1, 2011, then tasks T0, T1, T2, and T3 can be performed. Further, one or more task layer services that prepare a payload can also refer to the effective date indicated in the table, and select the data for the appropriate date range. Thus, a date effectivity feature can assist a user in adding or removing transfer pricing rules or tasks for any given date range. Without this feature, it is very difficult for a user to specify different sets of transfer pricing rules and/or tasks for an agreement with different date ranges. Thus, the date effectivity feature can help a user configure a setup in accordance with modifications to business requirements.

Further, in one embodiment, a supply chain financial orchestration system can provide objects (such as transfer pricing rules or tasks) with both date effectivity and multiple language support (“MLS”). Thus, the supply chain financial orchestration system can enable a user to create multi-lingual objects that also extend the date effectivity behavior previously described. By extending the date effectivity behavior into MLS-enabled attributes, the supply chain financial orchestration system can keep track of modifications to MLS-enabled attributes. The supply chain financial orchestration system can enable support for date effective operations, such as “Create,” “Retrieve,” “Insert,” “Correct,” “End Date,” and “Delete,” as well as operations, such as import and export of setup data between systems. By utilizing this framework, a user can enable date effective behavior for MLS entities. Without this framework, a user would likely have to manually create source code to support date effective operations for translatable attributes, or would have to drop either the date effectivity behavior or the MLS-enabled attributes.

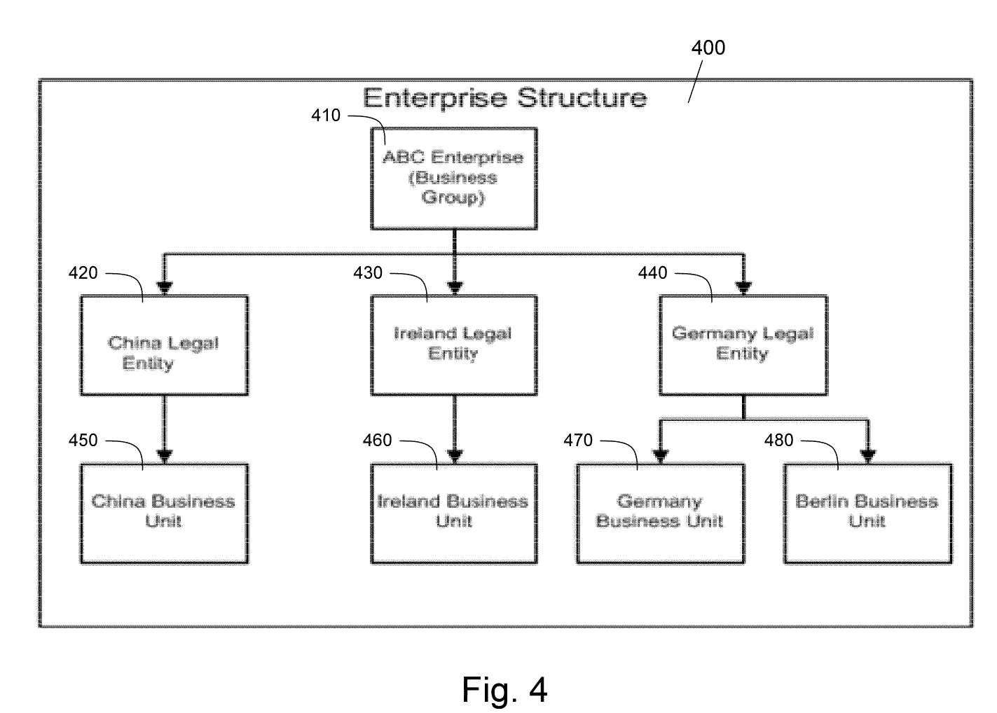

FIG. 4 illustrates an example enterprise structure 400, according to an embodiment of the invention. Enterprise structure 400 is an enterprise structure of ABC enterprise 410 (a large corporation) spread across different countries involved in internal trade relationships. More specifically, ABC enterprise 410 is a multinational company that includes a China legal entity 420, an Ireland legal entity 430, and a Germany legal entity 440. A China business unit 450 is a profit center that belongs to China legal entity 420. China business unit 450 operates as a purchasing affiliate in China. An Ireland business unit 460 is principal profit center that belongs to Ireland legal entity 430. Ireland business unit 460 falls under a low tax jurisdiction. A Germany business unit 470 and a Berlin business unit 480 are profit centers that belong to Germany legal entity 440. Germany business unit 470 and Berlin business unit 480 operate as manufacturing hubs in Europe.

An internal trade relationship can be of two types: a relationship for an inter-company trade and a relationship for an intra-company trade. An inter-company trade is a trade of goods or services between two business units belonging to a common group of legal entities. An example inter-company trade is a trade between China business unit 450 and Germany business unit 470, which belong to different legal entities (i.e., China legal entity 420 and Germany legal entity 440). An intra-company trade is a trade of goods or services between two business units that belong to a single legal entity. An example intra-company trade is a trade between Germany business unit 470 and Berlin business unit 480, which belong to a single legal entity (i.e., Germany legal entity 440).

According to the embodiment, there can be a separate physical flow and financial flow for an internal trade relationship between business units of ABC enterprise 410. For the physical flow, a supplier located in China can ship the goods to Germany business unit 470. However, for the financial flow, the supplier in China can transfer the ownership of goods to China business unit 450 when the goods are received at a Germany warehouse owned by Germany business unit 470. China business unit 450 entitles to the ownership of the goods and is also liable to pay the supplier in China at this point in time. This is also the point in time when the ownership of goods passes from China business unit 450 to Germany business unit 470. At this point, Germany business unit 470 entitles the goods and is also liable to pay China business unit 450. The financial settlement between China business unit 450 and Germany business unit 470 can be routed through Ireland business unit 460, in order to attain significant tax benefit along with optimizing operational efficiencies. Receivables and payables invoices can be generated and booked in the seller's and buyer's accounting books, typically at the time of ownership transfer.

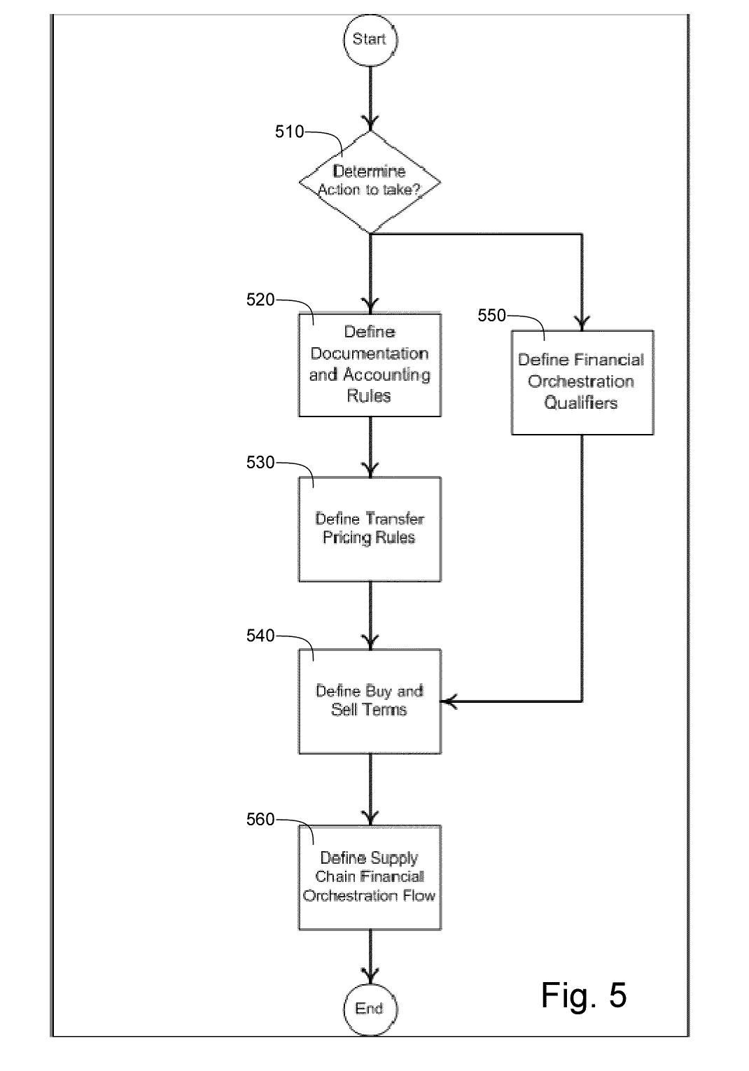

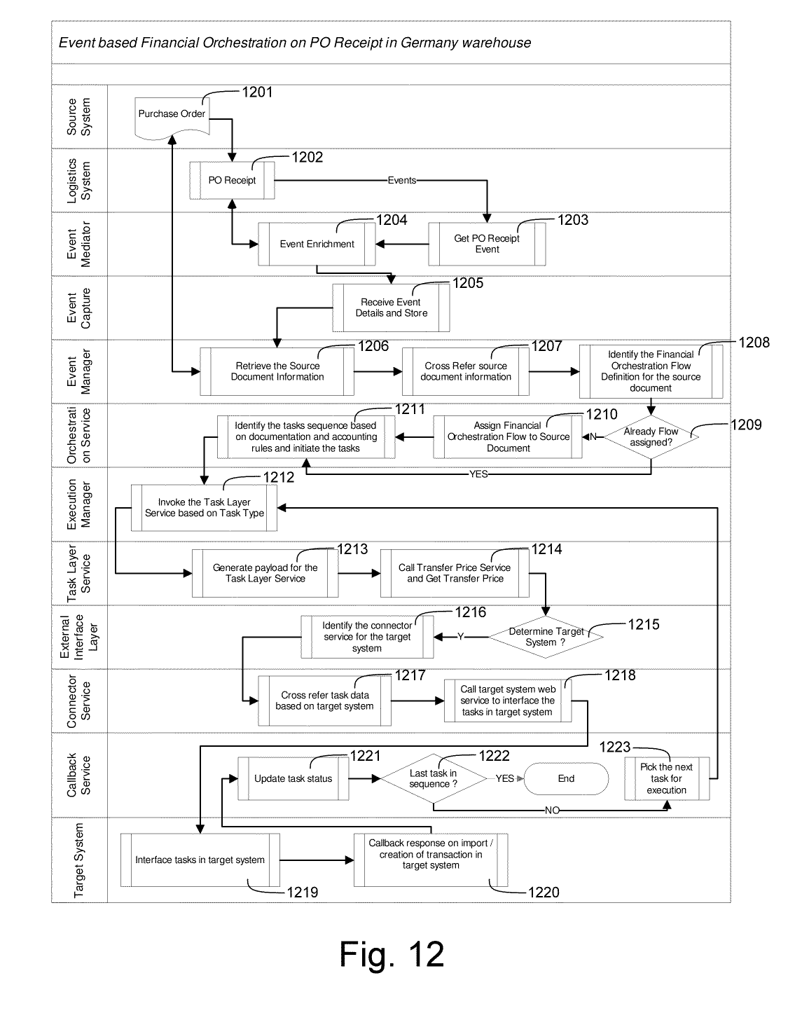

FIG. 5 illustrates a flow diagram of the functionality of a supply chain financial orchestration flow module (such as supply chain financial orchestration flow module 16 of FIG. 1), according to an embodiment of the invention. In one embodiment, the functionality of the flow diagram of FIG. 5, and the functionality of the flow diagram of FIG. 12, are each implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. In certain embodiments, some, but not all, of each functionality may be implemented.

According to the embodiment, a supply chain financial orchestration flow module can define one or more supply chain financial orchestration flows. As previously describes, a supply chain financial orchestration flow can define a trade relationship between two entities. In certain embodiments, the two entities can be two internal legal entities of an overall enterprise. In other embodiments, a first entity can be an internal legal entity of an overall enterprise, and a second entity can be an external entity. According to the embodiment, a supply chain financial orchestration flow can include one or more documentation and accounting rules, one or more transfer pricing rules, one or more agreements (i.e., buy and sell terms), and/or one or more qualifier rules (i.e., one or more qualifiers). Each of the one or more documentation and accounting rules, transfer pricing rules, agreements, and/or qualifiers can define aspects of the trade relationship between the two entities, as is described below in greater detail.

The flow begins and proceeds to 510. At 510, it is determined which actions are to be taken to define one or more supply chain financial orchestration flows. The actions can include at least one of: defining one or more documentation and accounting rules; defining one or more transform pricing rules; defining one or more agreements; defining one or more supply chain financial orchestration flows; or defining one or more qualifiers. The flow then proceeds to either 520 or 550. In certain embodiments, at least one of 520, 530, and 540 is performed, as well as 550, when 550 can be performed at any time.

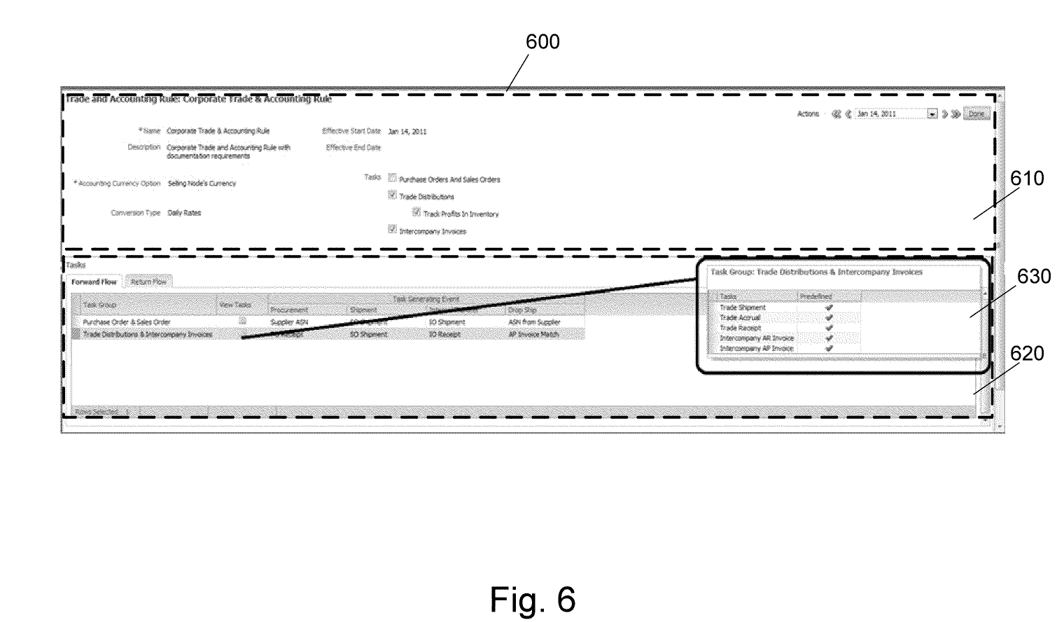

At 520, one or more documentation and accounting rules are defined. A documentation and accounting rule defines one or more tasks to be executed. In certain embodiments, the one or more tasks can be financial tasks that effect an ownership change of an item from a first entity to a second entity. In other embodiments, the one or more tasks can be tasks that create one or more documents (such as a purchase order, a sales order, or a customs invoice). The one or more documents can be created either prior to, or subsequent to, an ownership change of the item from the first entity to the second entity. A documentation and accounting rule can be defined as part of (i.e., associated with) a supply chain financial orchestration flow. More specifically, in certain embodiments, a documentation and accounting rule can be defined as part of (i.e., associated with) an agreement, where the agreement is defined as part of (i.e., associated with) the supply chain financial orchestration flow. Documentation and accounting rules are further described below in greater detail in conjunction with FIG. 6. In certain embodiments, where one or more documentation and accounting rules have already been defined, 520 can be omitted. The flow then proceeds to 530.

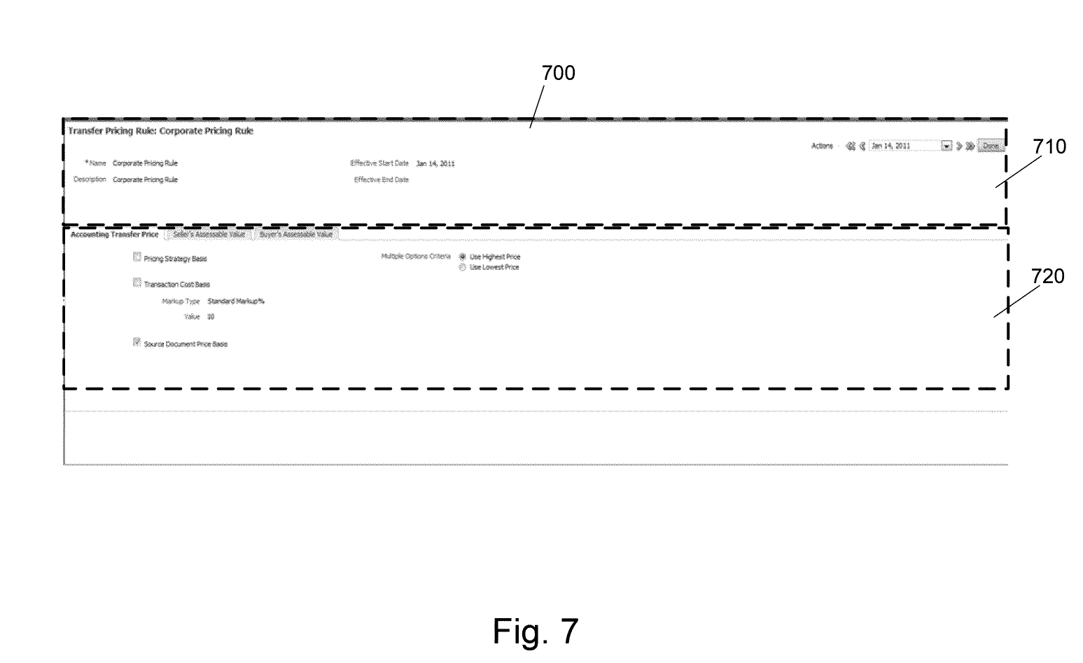

At 530, one or more transfer pricing rules are defined. A transfer pricing rule is a rule for automatically calculating a transfer price for an internal transaction. A transfer pricing rule can be defined as part of (i.e., associated with) a supply chain financial orchestration flow. More specifically, in certain embodiments, a transfer pricing rule can be defined as part of (i.e., associated with) an agreement, where the agreement is defined as part of (i.e., associated with) the supply chain financial orchestration flow. Transfer pricing rules are further described below in greater detail in conjunction with FIG. 7. In certain embodiments, where one or more transfer pricing rules have already been defined, 530 can be omitted. The flow then proceeds to 540.

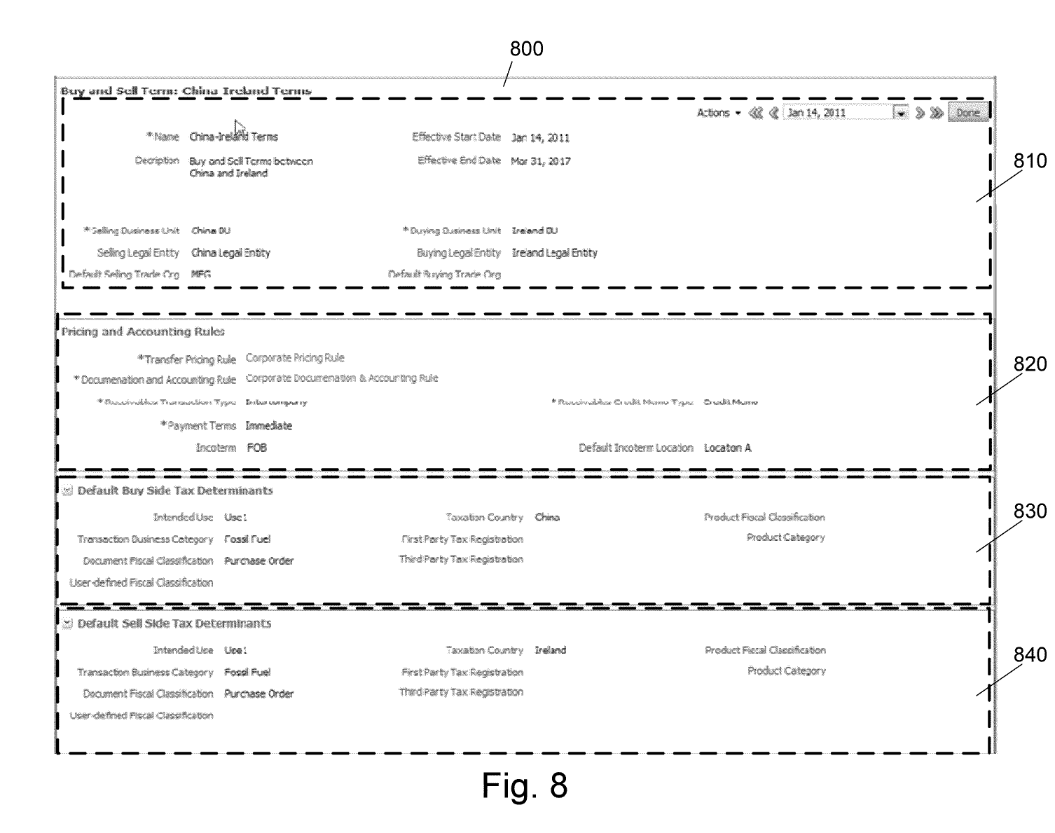

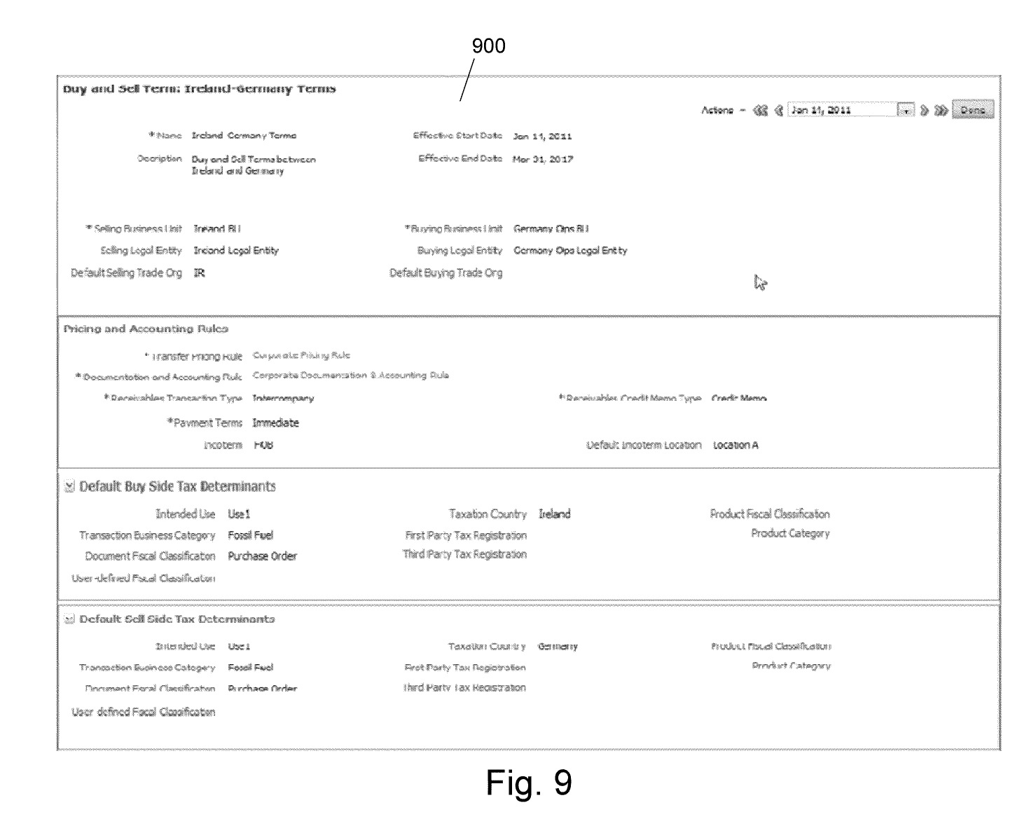

At 540, one or more agreements (identified in FIG. 5 as “buy and sell terms”) are defined. An agreement defines a trade relationship between two entities. One or more documentation and accounting rules can be defined as part of (i.e., associated with) an agreement. Further, one or more transfer pricing rules can be defined as part (i.e., associated with) an agreement. An agreement can be defined as part of (i.e., associated with) a supply chain financial orchestration flow. Agreements are further described below in greater detail in conjunction with FIGS. 8 and 9. In certain embodiments, where one or more agreements have already been defined, 540 can be omitted. The flow then proceeds to 560.

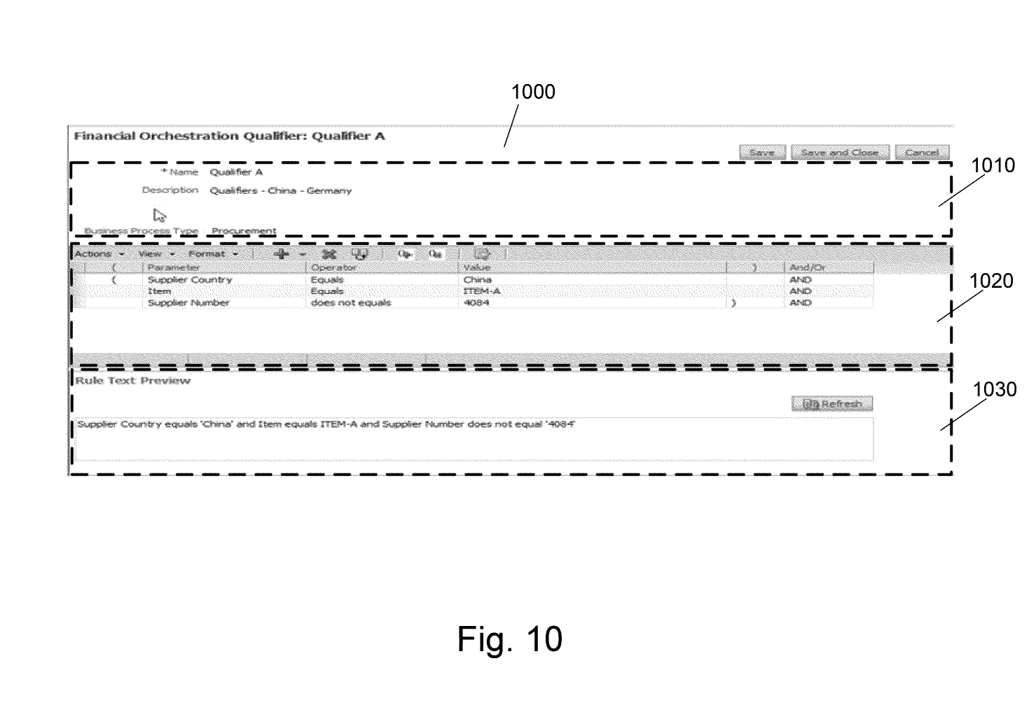

At 550, one or more qualifiers are defined. A qualifier is a rule for determining an applicability of a supply chain financial orchestration flow. One or more qualifiers can be defined as part of (i.e., associated with) a supply chain financial orchestration flow. Qualifiers are further described below in greater detail in conjunction with FIG. 10. Further, defining one or more qualifiers can be independent from defining one or more documentation and accounting rules, one or more transfer pricing rules and/or one or more agreements. In certain embodiments, where one or more qualifiers have already been defined, 550 can be omitted. The flow then proceeds to 560.

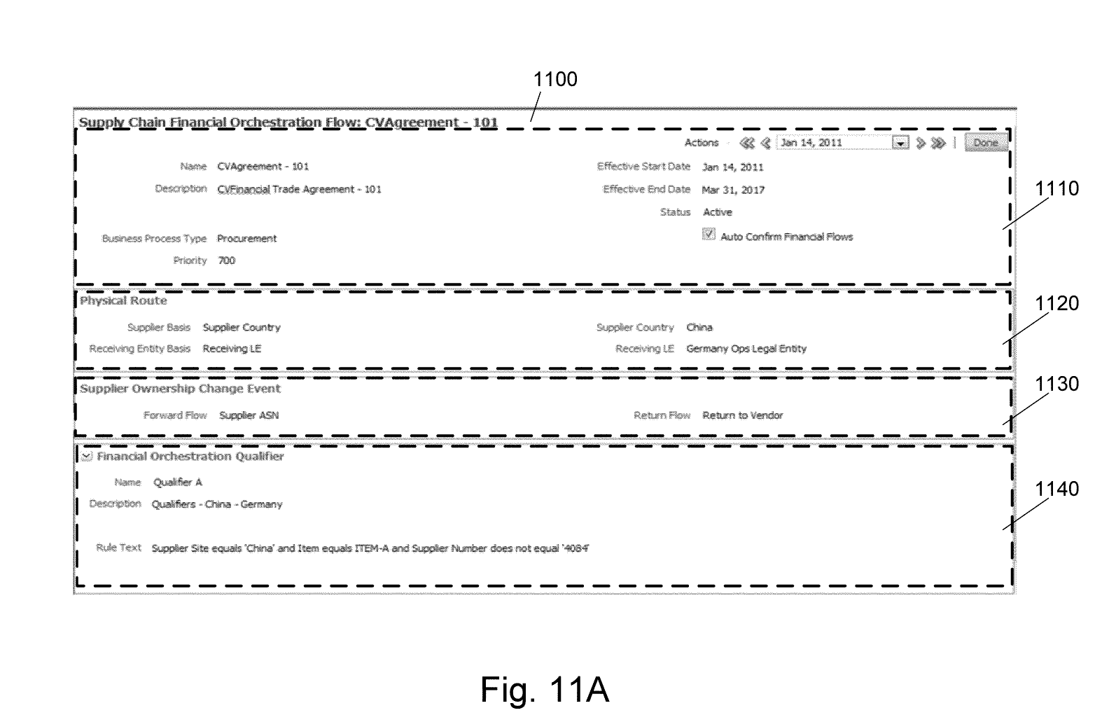

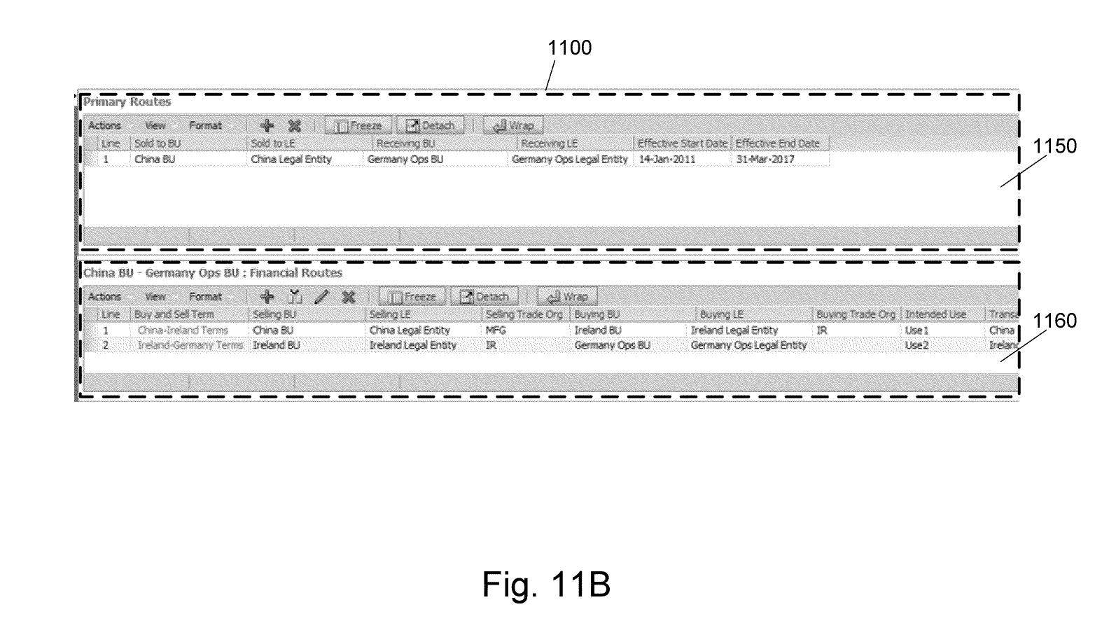

At 560, one or more supply chain financial orchestration flows are defined. A supply chain financial orchestration flow defines a trade relationship between a first entity and a second entity. More specifically, a supply chain financial orchestration flow defines a physical flow of goods from the first entity to the second entity and a financial flow of goods from the first entity to the second entity, where the physical flow can be independent of the financial flow. An agreement can be defined as part of (i.e., associated with) a supply chain financial orchestration flow. Further, one or more documentation and accounting rules and/or one or more transfer pricing rules can be defined as part of (i.e., associated with) an agreement. Additionally, one or more qualifiers can be defined as part of (i.e., associated with) a supply chain financial orchestration flow. Supply chain financial orchestration flows are further described below in greater detail in conjunction with FIGS. 11A and 11B. The flow then ends.

FIG. 6 illustrates an example user interface 600 for defining a documentation and accounting rule, according to an embodiment of the invention. As previously described, a documentation and accounting rule defines one or more tasks to be executed. In certain embodiments, the one or more tasks can be financial tasks that effect an ownership change of an item from a first entity to a second entity. In other embodiments, the one or more tasks can be tasks that create one or more documents (such as a purchase order, a sales order, or a customs invoice). The one or more tasks can be grouped into one or more task groups depending on a time when the one or more tasks are required to be created. Additionally, in some embodiments, one or more supply chain events that are ownership change events can be associated with the one or more task groups. The one or more supply chain events can include pre-defined supply chain events and/or user-defined supply chain events. A pre-defined supply chain event is a supply chain event that can be created by a supply chain financial orchestration system. A user-defined supply chain event is a supply chain event that can be created by a user of a supply chain financial orchestration system, rather than by the supply chain financial orchestration system itself.

According to the embodiment, user interface 600 includes documentation and accounting rule details window 610. Documentation and accounting rules details window 610 displays details of the displayed documentation and accounting rule, such as name, description, accounting currency option, conversion type, one or more task groups, effective start date, and effective end date. A name can define a name of the documentation and accounting rule. A description can define a description of the documentation and accounting rule. An accounting currency option can define a trading currency option used to specify a currency in which transactions associated with the documentation and accounting rule, such as internal transactions, will be denominated. Example accounting currency options can include: seller's currency (i.e., a currency of a selling entity); buyer's currency (i.e., a currency of a purchasing entity); a document currency (i.e., a currency of a source document); or a user-defined currency (i.e., a currency defined by a user). A conversion type can define a conversion of a first currency to a second currency. A task group can define a group of one or more tasks defined for the documentation and accounting rule.

An effective start date can define an effective start date for the documentation and accounting rule, and an effective end date can define an effective end date for the documentation and accounting rule. More specifically, a documentation and accounting rule can be date effective. This means that any modification to a documentation and accounting rule can cause a new effective date to be associated with the documentation and accounting rule. Thus, a source document created before the effective date of the modification can follow the original documentation and accounting rule, and a source document created after the effective date of the modification can follow the modified documentation and accounting rule.

User interface 600 further includes documentation and accounting rule tasks window 620. Documentation and accounting rule tasks window 620 displays one or more task groups. Example task groups can include “Purchase Order & Sales Order” and “Trade Distributions & Intercompany Invoices.” Documentation and accounting rule tasks window 620 further displays one or more supply chain events that are defined as task generating events, where each supply chain event can be defined as a task generating event for a supply chain financial orchestration flow type (i.e., business process type). Example supply chain financial orchestration flow types include a global procurement flow (identified in FIG. 6 as “Procurement”), an internal drop shipment flow (identified in FIG. 6 as “Shipment”), a customer drop shipment flow (identified in FIG. 6 as “Drop Ship”), or an internal transfer flow (identified in FIG. 6 as “Internal Transfer”). Also according to the illustrated embodiment, one or more supply chain events can be defined as task generating events for a forward flow using a forward flow tab, and an additional set of one or more supply chain events can be defined as task generating events for a return flow using a return flow tab. According to certain embodiments, a supply chain financial orchestration flow can include a forward flow and a return flow, where a forward flow is a flow of events that proceeds in a specific direction (such as from a supplier entity to a purchaser entity), and where a return flow is a flow of events that proceeds in a reverse direction (such as from a purchaser entity to a supplier entity).

According to the illustrated embodiment, a user can select a task group within documentation and accounting rule tasks window 620 of FIG. 6, and cause task group tasks window 630 to be displayed. Task group tasks window 630 displays one or more tasks of a task group, and further displays whether each task is pre-defined or user-defined. A user can add one or more new tasks to the task group, or can delete one or more existing tasks from the task group.

Further, a documentation and accounting rule can be configured to meet country-specific inter-company or intra-company regulatory requirements. For example, in a supply chain financial orchestration flow for a global procurement, documents such as purchase orders or sales orders may be required to be created at a time of shipment of goods from the supplier as part of the document. However, the ownership can be transformed from a purchasing entity that is purchasing the goods from a supplier, to a receiving entity that receives the goods only when the goods are received at the destination.

FIG. 7 illustrates an example user interface 700 for defining a transfer pricing rule, according to an embodiment of the invention. As previously described, a transfer pricing rule is a rule for automatically calculating a transfer price for an internal transaction. According to the embodiment, user interface 700 includes transfer pricing rule details window 710. Transfer pricing rule details window 710 displays details of the displayed transfer pricing rule, such as name, description, effective start date, and effective end date. A name can define a name of the transfer pricing rule. A description can define a description of the transfer pricing rule.

An effective start date can define an effective start date for the transfer pricing rule, and an effective end date can define an effective end date for the transfer pricing rule. More specifically, a transfer pricing rule can be date effective. This means that any modification to a transfer pricing rule can cause a new effective date to be associated with the transfer pricing rule. Thus, transactions associated with new source documents created after an effective date can utilize the modified transfer pricing rule to calculate a transfer price, while transactions associated with original source documents created before the effective date can utilize the original transfer price rule to calculate the transfer price. A supply chain financial orchestration system, when deriving the transfer pricing rules for calculating a transfer price, can retrieve the transfer pricing rules that are effective as of an effective date for a source document.

User interface 700 further includes transfer pricing options window 720. Transfer pricing options window 720 allows a user to select one or more options for defining a transfer pricing rule. One option for defining a transfer pricing rule is a pricing strategy-based transfer price option that defines a pricing strategy-based transfer pricing rule. A pricing strategy-based transfer pricing rule calculates a transfer price based on a pricing strategy, where a pricing strategy is a collection of one or more pricing rules that define an approach for achieving a specific goal associated with selling and pricing products, where the specific goal can be targeted at a pricing segment and/or a specific selling situation. The one or more rules can be defined in a pricing system, and the collection of the one or more defined rules can form a pricing strategy. Another option for defining a transfer pricing rule is a transaction cost-based transfer price option that defines a transaction cost-based transfer pricing rule. A transaction cost-based transfer pricing rule calculates a transfer price by applying a positive or negative markup over a cost incurred by a selling entity for an item or service (i.e., a transaction cost). The markup can be a standard markup, which can be specified as a percentage. The markup can be an advanced markup defined using one or more pricing term rules of a pricing system. A pricing term rule is a rule which defines how a price of an item or service can be adjusted or defined. Another option for defining a transfer pricing rule is a source document price-based transfer price option that defines a source document-based transfer pricing rule. A source document price-based transfer pricing rule calculates a transfer price by applying a positive or negative markup over a source document price, such as a purchase order price or a sales order price.

According to the embodiment, transfer pricing options window 720 further includes a multiple options criteria, where a multiple options criteria is a feature that enables a combination of multiple transfer pricing rules options. Thus, a transfer pricing rule can calculate a transfer pricing using multiple options, and thus, produce multiple transfer prices, and a transfer price can be selected from the multiple transfer prices. Based on a selection that the user makes, either a highest transfer price from the multiple transfer prices can be selected, or a lowest transfer price from the multiple transfer prices can be selected.

Further, according to the embodiment, transfer pricing options window 720 allows a user to define a transfer pricing rule to calculate an assessable value for an internal transaction. An assessable value is the value of an internal transaction for tax calculation purposes. A separate assessable value can be calculated for a seller of the internal transaction, and a buyer of the internal transaction. Transfer pricing options window further provides an option to either use a transfer price as an assessable value, or define a separate rule (or set of rules) to calculate the assessable value.

FIG. 8 illustrates an example user interface 800 for defining an agreement (identified in FIG. 8 as a “buy and sell term”; also identified as a “financial orchestration flow”), according to an embodiment of the invention. In any supply chain financial orchestration flow that includes a purchase or transfer of goods, the purchasing entity and the selling entity (or the two transferring entities) agree upon one or more supply chain events that define a transfer of title, cost, and risk of the goods, from the selling entity to the purchasing entity (or from the first transferring entity to the second transferring entity). This may be explicitly agreed upon in an agreement (i.e., buy and sell term). As previously described, a supply chain event is an event that occurs in the process of execution of a supply chain flow. A supply chain event can be a physical execution event, such as a shipment or receipt of goods, or a trade event, such as a transfer of ownership of the goods.

According to the embodiment, user interface 800 allows a user to define a trade relationship between two entities, such as profit center business units involved in an internal transaction. The definition can be a reusable definition, where a single defined agreement can be referred to across multiple supply chain financial orchestration flows between the two entities. There can also be more than one agreement defined between the same pair of entities.

According to the embodiment, user interface 800 includes agreement details window 810. Agreement details window 810 displays details of the displayed agreement, such as name, description, selling business unit, selling legal entity, buying business unit, buying legal entity, effective start date, and effective end date. A name can define a name of the agreement. A description can define a description of the agreement. A selling business unit can define a business unit of a selling entity. A selling legal entity can define a selling entity. A buying business unit can define a business unit of a purchasing entity. A buying legal entity can define a purchasing entity.

An effective start date can define an effective start date for the agreement, and an effective end date can define an effective end date for the agreement. More specifically, an agreement can be date effective. This means that any modification to an agreement can cause a new effective date to be associated with the agreement. Thus, transactions associated with a new source document created after the effective date can follow the new agreement while transactions associated with an original source document created before the effective date can follow the original agreement.

According to the embodiment, user interface 800 includes pricing and accounting rules window 820. Pricing and accounting rules window 820 allows a user to define a transfer pricing rule and a documentation and accounting rule for the displayed agreement. User interface 800 further includes default buy side tax determinants window 830 and default sell side tax determinants window 840. Default buy side tax determinants window 830 allows a user to define a tax jurisdiction for a purchasing entity. Default sell side tax determinants window 840 allows a user to define a tax jurisdiction for a selling entity.

In the illustrated embodiment, the agreement displayed within user interface 800 is an agreement between a China business unit and an Ireland business unit. According to the embodiment, the agreement can be defined for a first portion of a supply chain financial orchestration flow between a China business unit and a Germany business unit, where a second portion is further described below in greater detail in conjunction with FIG. 9.

FIG. 9 illustrates another example user interface 900 for defining an agreement (identified in FIG. 9 as a “buy and sell term”; also identified as a “financial orchestration flow”), according to another embodiment of the invention. User interface 900 is identical to user interface 800, but user interface 900 displays an agreement between an Ireland business unit and a Germany business unit. According to the embodiment, the agreement can be defined for second portion of a supply chain financial orchestration flow between a China business unit and a Germany business unit, where a first portion is previously described in conjunction with FIG. 8. Thus, as illustrated in FIGS. 8 and 9, different agreements can be defined for different portions of a supply chain financial orchestration flow, which means that different documentation and accounting rules and/or transfer pricing rules can be applied to different portions of a supply chain financial orchestration flow.

FIG. 10 illustrates an example user interface 1000 for defining a qualifier (identified in FIG. 10 as a “financial orchestration qualifier”), according to an embodiment of the invention. As previously described, a qualifier is a rule for determining an applicability of a supply chain financial orchestration flow. More specifically, a qualifier can be used to determine whether a supply chain financial orchestration flow is applicable to a transaction or source document. The qualifier can include a specific number of conditions. If a sufficient amount of conditions of the qualifier are met, then the supply chain financial orchestration flow is applicable to the transaction or source document. If a sufficient amount of conditions of the qualifier are not met, then the supply chain financial orchestration flow is not applicable to the transaction or source document. A qualifier can be configurable by a user. Further, applicable attributes of a supply chain financial orchestration flow that are defined within a qualifier depend on a supply chain financial orchestration flow type (i.e., business process type).

According to the embodiment, user interface 1000 includes qualifier details window 1010. Qualifier details window 1010 displays details of the displayed qualifier, such as name, description, and supply chain financial orchestration flow type (identified in FIG. 10 as “business process type”). A name can define a name of the qualifier. A description can define a description of the qualifier. A supply chain financial orchestration flow type can define a type of supply chain financial orchestration flow that the qualifier can be associated with, and further defines the parameters that can be displayed within qualifier conditions window 1020, described below in greater detail. Example supply chain financial orchestration flow types can include a global procurement flow, a customer shipment flow, and an internal transfer flow.

User interface 1000 further includes qualifier conditions window 1020. Qualifier conditions window 1020 displays one or more conditions for determining an applicability of a supply chain financial orchestration flow. Each condition can include a parameter, a value, an operator, and an “and/or” indicator. A parameter can define an attribute of either a transaction or a source document. A value can define a value for the parameter. An operator can define a relationship between the parameter and the value. Example operators include “equals” and “does not equals.” An “and/or” indicator can define either a logical conjunction of two conditions (e.g., “condition 1 AND condition 2” evaluates to true when both condition) and condition 2 are true) or a logical disjunction of two conditions (e.g., “condition 1 OR condition 2” evaluates to true when condition 1 is true, or condition 2 is true, or both condition 1 and condition 2 are true).

User interface 1000 further includes qualifier rule text preview window 1030. Qualifier rule text preview window 1030 displays a preview of a text representation of the qualifier, which includes the one or more conditions of the qualifier. In the illustrated embodiments, the qualifier can determine whether a supplier country attribute is equal to “China,” whether an item attribute is equal to “ITEM-A,” and whether a supplier attribute is not equal to “4084.” Based on these determinations, the qualifier can determine whether the supply chain financial orchestration flow is applicable to the transaction or source document.

FIG. 11A illustrates a portion of an example user interface 1100 for defining a supply chain financial orchestration flow, according to an embodiment of the invention. As previously described, a supply chain financial orchestration flow defines a trade relationship between a first entity and a second entity. More specifically, a supply chain financial orchestration flow defines a physical flow of goods from the first entity to the second entity and a financial flow of goods from the first entity to the second entity, where the physical flow can be independent of the financial flow.

According to the illustrated embodiment, user interface 1100 includes supply chain financial orchestration flow details window 1110. Supply chain financial orchestration flow details window 1110 displays details of the displayed supply chain financial orchestration flow, such as name, description, supply chain financial orchestration flow type (illustrated in FIG. 11A as “business process type”), priority, status, auto confirm financial flow, effective start date, and effective end date. A name can define a name of the supply chain financial orchestration flow. A description can define a description of the supply chain financial orchestration flow. A supply chain financial orchestration flow type can define a type of the supply chain financial orchestration flow. Example supply chain financial orchestration flow types can include a global procurement flow, a customer shipment flow, and an internal transfer flow. A priority can define a priority that can be assigned to the supply chain financial orchestration flow. The assigned priority can be used to determine which supply chain financial orchestration flow to assign to the source document, when there is more than one supply chain financial orchestration flow available. In certain embodiments, the priority can be expressed as a number, so that a lower number has a higher priority. A status can define a status of the supply chain financial orchestration flow (i.e., whether the supply chain financial orchestration flow is available for orchestration). Example statuses can include “Active,” “Draft,” and “Cancelled.” An auto confirm financial flow is an attribute that can define whether the supply chain financial orchestration flow automatically starts orchestration of tasks for trade accounting and financial transactions, or else whether the supply chain financial orchestration flow waits for a user interaction to confirm the supply chain financial orchestration flow.

An effective start date can define an effective start date for the supply chain financial orchestration flow, and an effective end date can define an effective end date for the supply chain financial orchestration flow. More specifically, a supply chain financial orchestration flow can be date effective. This means that any modification to a supply chain financial orchestration flow can cause a new effective date to be associated with the supply chain financial orchestration flow. Thus, transactions associated with a new source document created after the effective date can follow the new supply chain financial orchestration flow while transactions associated with an original source document created before the effective date can follow the original supply chain financial orchestration flow.

User interface 1100 further includes physical route window 1120. Physical route window 1120 displays a physical route for a supply chain financial orchestration flow, where the physical route represents the physical movement of goods throughout the supply chain financial orchestration flow. The physical movement of goods can depend on a supply chain financial orchestration flow type. In the illustrated embodiment, physical route window 1120 displays a supplier basis, a supplier country, a receiving entity basis, and a receiving legal entity.

User interface 1100 further includes supplier ownership change event window 1130. Supplier ownership change event window 1130 displays one or more supplier ownership change events for a supply chain financial orchestration flow, where a supplier ownership change event is an event that indicates an ownership transfer from a supplier to a purchasing entity. A supplier ownership change event can trigger a task layer service to create logical receipt costing transactions for the purchasing entity. According to the illustrated embodiment, a supplier ownership change event can be defined for a forward flow of the supply chain financial orchestration flow and a separate supplier ownership change event can be defined for a return flow of the supply chain financial orchestration flow.

User interface 1100 further includes qualifier window 1140. Qualifier window 1140 displays a qualifier defined for a supply chain financial orchestration flow. As previously described, a qualifier is a rule for determining an applicability of a supply chain financial orchestration flow. As also previously described, a qualifier can be used to determine whether a supply chain financial orchestration flow is applicable to a transaction or source document. The qualifier can include a specific number of conditions. If a sufficient amount of conditions of the qualifier are met, then the supply chain financial orchestration flow is applicable to the transaction or source document. If a sufficient amount of conditions of the qualifier are not met, then the supply chain financial orchestration flow is not applicable to the transaction or source document.

FIG. 11B illustrates another portion of an example user interface 1100 for defining a supply chain financial orchestration flow, according to an embodiment of the invention. According to the illustrated embodiment, user interface 1100 includes primary route window 1150. Primary route window 1150 displays one or more primary routes for a supply chain financial orchestration flow, where a primary route establishes a supply chain execution partnership between two legal entities and their business units. A primary route further defines a financial flow for transacting goods and service between two primary trade partners. In certain embodiments, a first entity represents an internal selling entity, and a second entity represents an internal purchasing entity.

User interface 1100 further includes financial route window 1160. Financial route window 1160 displays one or more financial routes for a supply chain financial orchestration flow, where a financial route defines a financial trade relationship through which financial obligations are settled. A supply chain financial orchestration flow can have one or more financial trade relationships depending on the number of intermediary parties included within the supply chain financial orchestration flow.

FIG. 12 illustrates a flow diagram of the functionality of a supply chain financial orchestration flow module, according to another embodiment of the invention. According to the embodiment, a supply chain financial orchestration flow module can orchestrate one or more supply chain events based on a supply chain financial orchestration flow. Thus, the supply chain financial orchestration flow module can support configurable event-based orchestration arising due to ownership transfer of good, and can integrate with several external systems.

As previously described, supply chain trade relationships of large corporations or global companies are typically spread across geographic locations and typically span multiple external systems. Physical movement and legal ownership of goods are often independent of each other, and financial transactions resulting in such trade relationship may need to support strict legal, tax, and management reporting requirements. Supply chain events, such as physical execution events or trade events, can be raised on transactions such as a shipment or receipt of goods at an agreed location, or a transit of goods to a port or destination. The source of these supply chain events can be different execution systems. When a supply chain event that indicates an ownership transfer of goods from a selling entity to a purchasing entity is raised, the selling entity can be required to account for costs, revenue, and receivables in his accounting books, and the purchasing entity can be required to account for inventory costs and payment liability in his accounting books. Further, an invoice may be generated and sent by the selling entity to the purchasing entity, which can become a legal document representing the accounting and payments.

An example flow for orchestrating a purchase order receipt supply chain event is described below, and illustrated in FIG. 12, where the purchase order receipt supply chain event is raised when goods sent by a supplier entity are received in a warehouse in Germany, where the purchase order receipt supply chain event indicates a transfer of ownership of goods from a selling entity to a purchasing entity, where the goods are associated with a purchase order. However, the example flow is not limited to the aforementioned supply chain event, and can apply to any supply chain event. According to the embodiment, the purchase order receipt supply chain event is defined as a task generating event within a supply chain financial orchestration system, and the supply chain financial orchestration system listens for the occurrence of a purchase order receipt supply chain event.

The flow begins and proceeds to 1201. A purchase order (or another source document, in other embodiments) is generated within an external source system. The flow then proceeds to 1202. At 1202, a purchase order receipt supply chain event (or another supply chain event, in other embodiments) is generated at an external logistics system and sent to an event mediator, where the supply chain event references the source document generated within the external source system. The flow then proceeds to 1203. At 1203, the supply chain event is received at the event mediator. The flow then proceeds to 1204. At 1204, the event mediator invokes a web service of the external logistics system and retrieves supply chain event information associated with the supply chain event from the external logistics system using the invoked web service. The flow then proceeds to 1205. At 1205, the supply chain event information associated with the supply chain event is validated at an event capture component, and the supply chain event is stored in an external source system format at the event capture component. The flow then proceeds to 1206.

At 1206, an event manager retrieves source document information associated with the source document generated within the external source system and referenced by the supply chain event. In one embodiment, the event manager retrieves the source document information by invoking a source document enrichment service exposed by the external source system. The event manager passes a source document identifier as an input parameter to the source document enrichment service and retrieves the source document information from the source document enrichment service. The source document identifier can be part of the supply chain event information previously retrieved from the external source system. The flow then proceeds to 1207. At 1207, the event manager transforms (identified in FIG. 12 as “cross-refer”) the source document information into an internal format. The flow then proceeds to 1208. At 1208, the event manager identifies a supply chain financial orchestration flow for the source document. In one embodiment, the event manager can identify a supply chain financial orchestration flow using at least one of: a qualifier, a source document type, a physical route, a selling entity, a purchasing entity, a priority, an effective start date, or an effective end date. The flow then proceeds to 1209. At 1209, it is determined at an orchestration service whether the identified supply chain financial orchestration flow is assigned to the source document. If the identified supply chain financial orchestration flow is assigned to the source document, the flow proceeds to 1211. If the identified supply chain financial orchestration flow is not assigned to the source document, the flow proceeds to 1210. At 1210, the orchestration service assigns the identified supply chain financial orchestration flow to the source document. The flow then proceeds to 1211. At 1211, the orchestration service identifies and selects one or more tasks defined for the supply chain financial orchestration flow based on one or more documentation and accounting rules. In one embodiment, the one or more tasks can be defined for the one or more documentation and accounting rules, and the orchestration service can identify and select the one or more tasks defined for the one or more documentation and accounting rules. Further, in one embodiment, the orchestration service can identify and select one or more tasks defined for a supply chain financial orchestration type. Even further, in one embodiment, the orchestration service can identify and select one or more tasks defined for either a forward flow or a return flow. The orchestration service further initiates the one or more tasks. The flow then proceeds to 1212.

At 1212, for a task of the one or more tasks, an execution manager invokes a task layer service based on a task type of the task. Example task types can include internal trade documents (such as a purchase order and a sales order), trade distribution tasks, and intercompany invoices. A task type can also be a user-defined task type. The flow then proceeds to 1213. At 1213, the invoked task layer service generates a task layer service payload. In one embodiment, the task layer service includes logic to populate the task layer service payload with data depending on a supply chain financial orchestration flow type of the supply chain financial orchestration flow. The flow then proceeds to 1214. At 1214, the task layer service calls a transfer price service, where the transfer price service calculates a transfer price for the task, and the task layer service retrieves the transfer price from the transfer price service. The flow then proceeds to 1215. At 1215, an external interface layer service selects an external target system to execute the task. In one embodiment, the external interface layer service selects an external target system based on a task type of the task. The flow then proceeds to 1216. At 1216, the external interface selects a connector service for the selected external target system. In one embodiment, the external interface layer service also selects the connector service based on a task type of the task. The flow then proceeds to 1217. As 1217, the selected connector service transforms (identified in FIG. 12 as “cross-refer”) the task layer service payload into an external target system format (i.e., a format that is understood by the selected external target system). The flow then proceeds to 1218. At 1218, the selected connector service calls a web service of the selected external target system to interface with the selected external target system to execute the task. In one embodiment, the selected connector service can call the web service to interface the task within one or more interface tables of the selected external target system. The flow then proceeds to 1219.

At 1219, the selected external target system interfaces the task. The flow then proceeds to 1220. At 1220, the selected external target system sends a callback response to a callback service upon an execution of the task within the selected external target system. In one embodiment, the callback response is sent upon an importation or creation of a transaction in the selected external target system. The flow then proceeds to 1221. At 1221, the callback service receives the callback response sent from the selected external target system, and updates a status of the task. The flow then proceeds to 1222. At 1222, the callback service determines whether the executed task is the last task to be executed. If the executed task is the last task to be executed, the flow ends. If the executed task is not the last task to be executed, the flow proceeds to 1223. At 1223, the callback service selects the next task for execution. The flow then returns to 1212.

FIG. 13 illustrates an example user interface 1300 for managing supply chain event exceptions, according to an embodiment of the invention. According to the embodiment, a user can utilize user interface 1300 to view, troubleshoot and manage supply chain events which faulted due to a setup or technical reason. User interface 1300 includes search window 1310, which allows a user to enter supply chain event criteria. Example supply chain event criteria can include: a supply chain event type, a supply chain event identifier, a supply chain event date, an item identifier, a source document identifier, or an inter-organization transaction identifier. User interface 1300 further includes search results window 1320, which displays one or more supply chain event exceptions that arise during capture of a supply chain event and during processing of a supply chain event by an event manager, where the supply chain event meets the supply chain event criteria entered within search window 1310. In other words, all the supply chain events that both: (a) raise an exception; and (b) meet the supply chain criteria entered within search window 1310, are displayed within search results window 1320.

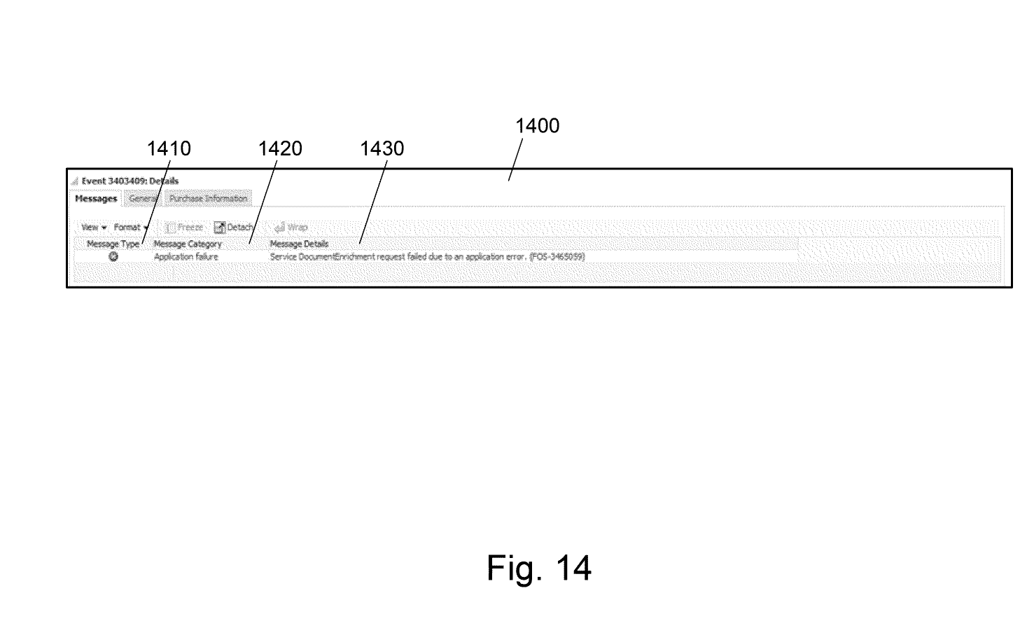

FIG. 14 illustrates a portion 1400 of an example user interface 1300 for managing supply chain event exceptions, where user interface portion 1400 can display a supply chain event exception message, according to an embodiment of the invention. According to the embodiment, user interface portion 1400 can display messages logged by a supply chain financial orchestration system, where each message is logged when an exception arises during processing of a supply chain event. A user is able to view each message within user interface portion 1400 and troubleshoot each message. More specifically, for each message, user interface portion 1400 displays a message type 1410, a message category 1420, and message detail 1430. Message type 1410 indicates a type of a message, when an example message type is an exception message. Message category 1420 indicates a category of error that triggered the exception. Example message categories include “application error,” “invalid event data,” “supply chain financial orchestration flow not found,” “event submission failed,” and “referenced events.” Message detail 1430 indicates the actual content of the message. In certain embodiments, a supply chain event exception arises if: (a) the supply chain event data is invalid, or required attributes for processing the flow are missing; (b) retrieval of the source document fails as the service is down; (c) no valid supply chain financial orchestration flow is identified for a source document; (d) a submitted user action fails to raise supply chain events for reprocessing of supply chain events which met with an exception; or (e) a return flow supply chain event has a reference to a forward flow, and the forward flow is not executed.

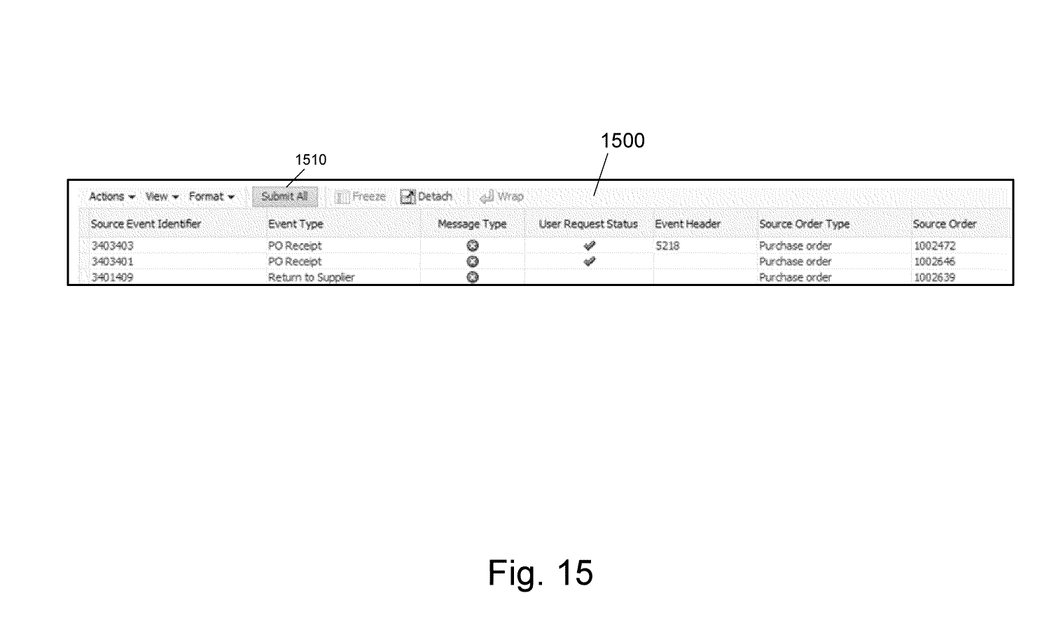

FIG. 15 illustrates a portion 1500 of an example user interface 1300 for managing supply chain event exceptions, where user interface portion 1500 can submit supply chain events for re-processing, according to an embodiment of the invention. According to the embodiment, if a user desires to re-process one or more supply chain events which raised an exception, a user can use user interface portion 1500 to query one or more supply chain events based on message category. A user can then select submit all button 1510 to re-process the queried supply chain event(s). Submit all button 1510 raises the queried supply chain event(s) to an event manager (such as event manager 303 of FIG. 3), and the event manager re-processes the supply chain event(s). If the action is successful, and the supply chain event(s) raised on submission is/are successfully acknowledged by the event manager for re-processing, the acknowledgement is displayed within user interface portion 1500 as an icon (such as a green check icon). If the supply chain event submission fails due to a technical reason, the failure is displayed within user interface portion 1500 as a different icon (such as a red error icon).

FIG. 16 illustrates a user interface 1600 for confirming an assignment of a supply chain financial orchestration flow, according to an embodiment of the invention. According to the embodiment, user interface 1600 allows a user to confirm a supply chain financial orchestration flow has been correctly defined and assigned to a source document, before the tasks defined for the supply chain financial orchestration flow are initiated by an orchestration service for creation of accounting and financial transactions in external target systems. There is a possibility that a referenced supply chain financial orchestration flow is not defined, or that an incorrect supply chain financial orchestration flow gets assigned to a source document, due to an incorrect setup. Thus, user interface 1600 gives an option to a user to validate a supply chain financial orchestration flow and confirm that the supply chain financial orchestration flow is correctly assigned to a source document before the tasks are initiated.

User interface 1600 includes search window 1610, which allows a user to enter supply chain financial orchestration flow criteria. Example supply chain financial orchestration flow criteria can include: a supply chain financial orchestration flow identifier, a supply chain financial orchestration flow type (i.e., business process type), a source business unit, a destination business unit, a source document type, a source document, an order date, or an item identifier. User interface 1600 further includes search results window 1620, which displays one or more source documents, where each source document is assigned to a supply chain financial orchestration flow that meets the supply chain financial orchestration flow criteria entered within search window 1610. Each source document that is assigned to a supply chain financial orchestration flow can be identified by a unique identifier (identified in FIG. 16 as “orchestration number”). Thus, a user can view the source documents that are assigned to supply chain financial orchestration flows, where the source documents displayed within search results window 1620. If the user determines that the supply chain financial orchestration flow is correctly assigned to the source document, the user can confirm the assignment of the supply chain financial orchestration flow using user interface 1600. If the user determines that the supply chain financial orchestration flow is not correctly assigned, the user can re-assign a new supply chain financial orchestration flow to the source document using user interface 1600, provided that the new supply chain financial orchestration flow is defined, and that it qualifies to be assigned to the source document. In certain embodiments, search results window 1620 can display source documents assigned to a supply chain financial orchestration flow, where an automatic confirm financial flow attribute of each supply chain financial orchestration flow is assigned to “NO.” As previously described, an automatic confirm financial flow attribute is a flag that can be set when defining a supply chain financial orchestration flow.

FIG. 17 illustrates an example user interface 1700 for monitoring an execution of a supply chain financial orchestration flow, according to an embodiment of the invention. According to the embodiment, user interface 1700 allows a user to monitor an execution of one or more tasks associated with the supply chain financial orchestration flow. The user can further manage any exceptions that arise due to functional or technical reasons as previously described. Once a supply chain financial orchestration flow is identified for a source document, and the one or more tasks associated with a supply chain financial orchestration flow are picked up by an orchestration service, the user can monitor and manage the execution of the one or more tasks using user interface 1700.

User interface 1700 includes search window 1710, which allows a user to enter supply chain financial orchestration flow criteria. Example supply chain financial orchestration flow criteria can include: a supply chain financial orchestration flow identifier, a supply chain financial orchestration flow type (i.e., business process type), a status, a message type, a message category, a source document identifier, or an item identifier. User interface 1700 further includes search results window 1720, which displays one or more source documents, where each source document is assigned to a supply chain financial orchestration flow that meets the supply chain financial orchestration flow criteria entered within search window 1710. Each source document that is assigned to a supply chain financial orchestration flow can be identified by a unique identifier (identified in FIG. 17 as “orchestration number”). Search results window 1720 can display a collective status of the one or more tasks associated with each supply chain financial orchestration flow, where the collective status is a roll-up of a task status for each task of the one or more status. Example collective statuses can include “Not Started,” “In Progress,” or “Completed.” Any task which has raised an exception due to a functional or technical reason can cause search results windows 1720 to display an error status as the collective status for the supply chain financial orchestration flow. Example error statuses can include “Error,” or “Warning.”

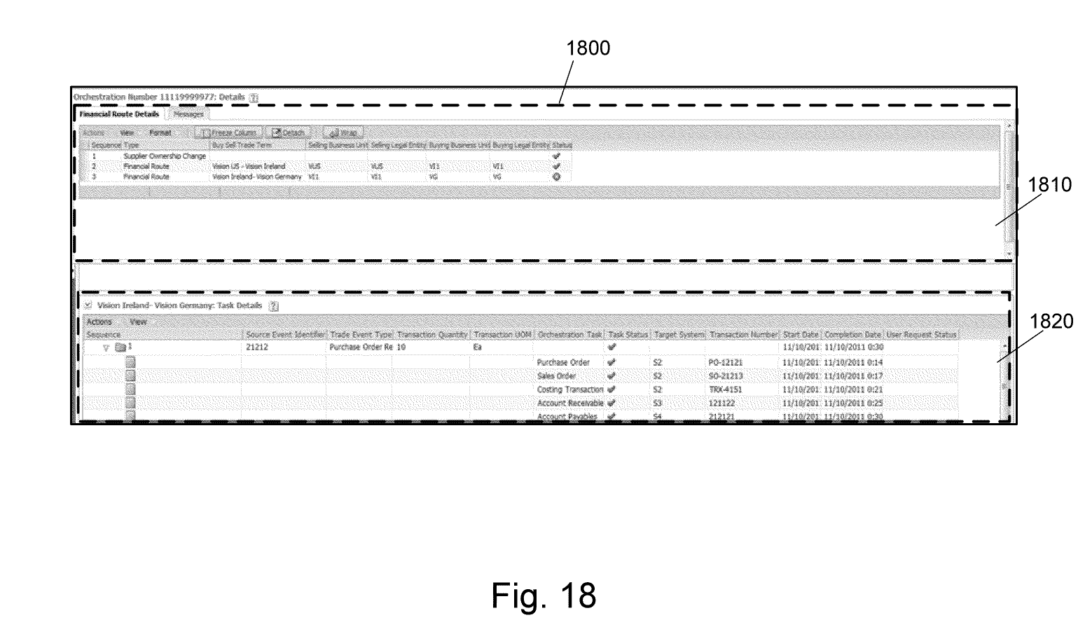

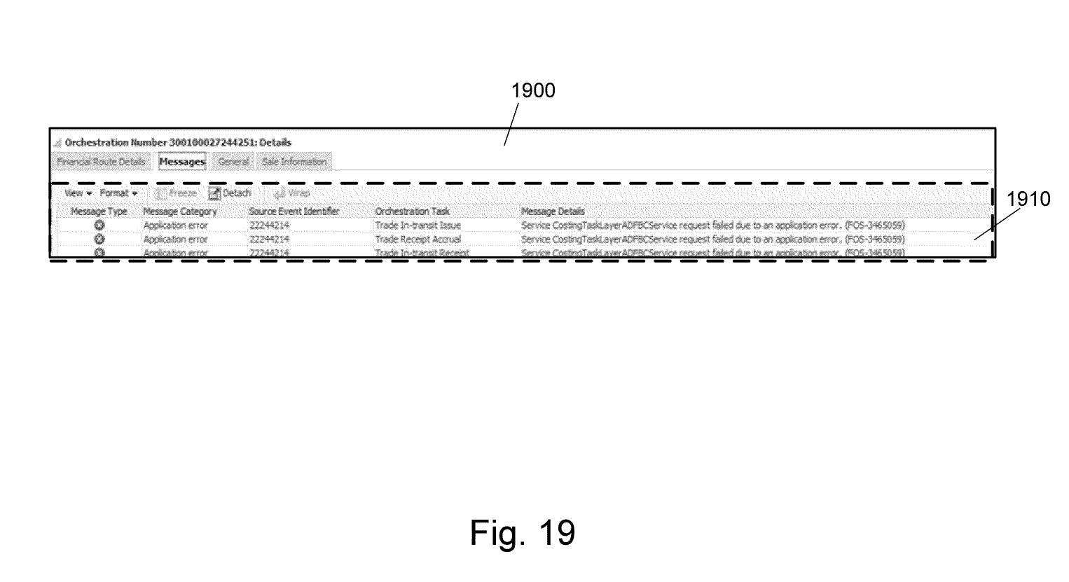

FIG. 18 illustrates a portion 1800 of an example user interface 1700 for monitoring an execution of a supply chain financial orchestration flow, where user interface portion 1800 can display details of a monitored supply chain financial orchestration flow, according to an embodiment of the invention. According to the embodiment, user interface portion 1800 includes supply chain financial orchestration flow details window 1810 and task details window 1820. Supply chain financial orchestration flow details window 1810 displays one or more financial routes associated with the supply chain financial orchestration flow that is assigned to a source document. Supply chain financial orchestration flow details window 1810 further displays one or more exceptions raised during execution of one or more tasks associated with the supply chain financial orchestration flow, as is further described in greater detail in conjunction with FIG. 19. Task details window 1820 displays one or more received supply chain events for a selected financial route in supply chain financial orchestration flow details window 1810. For each supply chain event, task details window 1820 displays one or more tasks being orchestrated based on the agreement for the financial route referred to in the supply chain financial orchestration flow.

FIG. 19 illustrates a portion 1900 of an example user interface 1700 for monitoring an execution of a supply chain financial orchestration flow, where user interface portion 1900 can display one or more exception messages for a monitored supply chain financial orchestration flow, according to an embodiment of the invention. According to the embodiment, user interface portion 1900 includes exception message window 1910. Exception message window 1910 displays a message category and message details for each exception that is raised during execution of a supply chain financial orchestration flow. This can allow a user to troubleshoot a cause for the exception, and resolve any issue. The message category broadly categorizes whether exception is due to application error, setup error, or submission error. An application error arises whenever any component of a supply chain financial orchestration system is down or not available, or a call to an internal or external service fails. A setup error arises due to a functional reason, such as missing setup data. A submission error arises if an event is not raised on a user action due to a technical reason. The message details include the specific details of the exception.

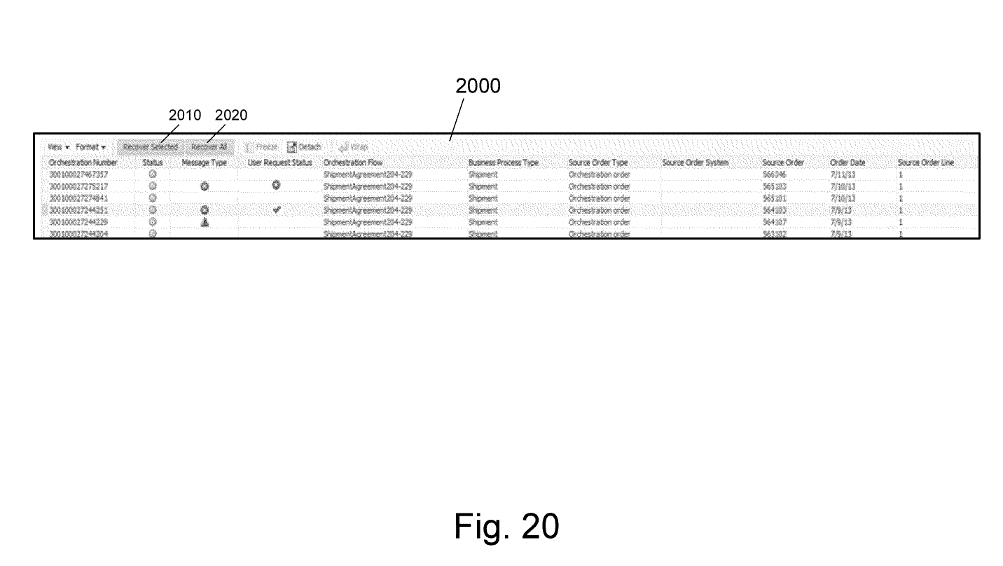

FIG. 20 illustrates a portion 2000 of an example user interface 1700 for monitoring an execution of a supply chain financial orchestration flow, where user interface portion 2000 can perform a recover action for a supply chain financial orchestration flow, according to an embodiment of the invention. According to the embodiment, user interface portion 2000 allows a user to either recover the supply chain financial orchestration flow, which re-performs all the tasks associated with the supply chain financial orchestration flow, or to recover one or more individual tasks associated with the supply chain financial orchestration flow, which re-performs the one or more individual tasks associated with the supply chain financial orchestration. Further, by selecting recover selected button 2010, a user can recover one or more supply chain financial orchestration flows selected within user interface portion 2000. By selecting recover all button 2020, a user can recover all the supply chain financial orchestration flows displayed within user interface portion 2000.

Thus, in one embodiment, a supply chain financial orchestration system can define a supply chain financial orchestration flow that can be utilized to indicate ownership of goods within supply chain transactions. The supply chain financial orchestration system can further orchestrate one or more supply chain events associated with the supply chain financial orchestration flow. Thus, the supply chain financial orchestration system can provide a robust foundation for integration with disparate business systems, as well as support for streamlined and configurable supply chain business processes, and support for complex financial flows typically spread across geographies.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to orchestrate a supply chain event, the orchestrating comprising:
receiving a supply chain event from an external source system;
retrieving source document information associated with a source document referenced by the supply chain event;
retrieving a supply chain financial orchestration flow assigned to the source document, wherein the supply chain financial orchestration flow defines a trade relationship between a first entity and a second entity;
selecting one or more tasks defined for the supply chain financial orchestration flow; and
initiating execution of the one or more tasks, where each task is executed at an external target system.

2. The computer-readable medium of claim 1, the orchestrating further comprising:
invoking a web service of the external source system;
retrieving supply chain event information associated with the supply chain event from the external source system using the invoked web service;
validating the retrieved supply chain event information of the supply chain event; and
storing the supply chain event in an external source system format.

3. The computer-readable medium of claim 1, the orchestrating further comprising:
transforming the source document information into an internal format.

4. The computer-readable medium of claim 1, the orchestrating further comprising:
determining whether a supply chain financial orchestration flow is assigned to the source document; and
assigning a supply chain financial orchestration flow to the source document where it is determined that no supply chain financial orchestration flow is assigned to the source document.

5. The computer-readable medium of claim 1, the orchestrating further comprising:
defining a documentation and accounting rule that is associated with the supply chain financial orchestration flow, wherein the one or more tasks are defined for the documentation and accounting rule;
defining a transfer pricing rule that is associated with the supply chain financial orchestration flow, wherein the transfer pricing rule defines a rule to calculate a transfer price;
defining an agreement that is associated with the supply chain financial orchestration flow, wherein the documentation and accounting rule and the transfer pricing rule are defined for the agreement; and
defining the supply chain financial orchestration flow, wherein the supply chain financial orchestration flow comprises a business process type, a physical route, a financial route, a primary route, and a supplier ownership change event.

6. The computer-readable medium of claim 5, the orchestrating further comprising:
defining a qualifier that is associated with the supply chain financial orchestration flow, wherein the qualifier comprises one or more attributes that determine an applicability of the supply chain financial orchestration flow.

7. The computer-readable medium of claim 1, wherein, for each task of the one or more tasks, the initiating the execution of the task further comprises:
invoking a task layer service based on a task type of the task;
generating a task layer service payload for the task layer service;
selecting the external target system based on the task type of the task; and
interfacing with the external target system to execute the task.

8. The computer-readable medium of claim 7, wherein, for each task of the one or more tasks, the initiating the execution of the task further comprises:
calling a transfer price service to calculate a transfer price for the task; and
retrieving the transfer price.

9. The computer-readable medium of claim 7, wherein, for each task of the one or more tasks, the initiating the execution of the task further comprises:
selecting a connector service for the external target system based on the task type of the task;
transforming the task layer service payload into an external target system format; and
calling a web service of the external target system to interface with the external target system to execute the task.

10. The computer-readable medium of claim 9, wherein, for each task of the one or more tasks, the initiating the execution of the task further comprises:
updating a status of the task after the task is executed.

11. A computer-implemented method for orchestrating a supply chain event, the computer-implemented method comprising:
receiving a supply chain event from an external source system;
retrieving source document information associated with a source document referenced by the supply chain event;
retrieving a supply chain financial orchestration flow assigned to the source document, wherein the supply chain financial orchestration flow defines a trade relationship between a first entity and a second entity;
selecting one or more tasks defined for the supply chain financial orchestration flow; and
initiating execution of the one or more tasks, where each task is executed at an external target system.

12. The computer-implemented method of claim 11, further comprising:
invoking a web service of the external source system;
retrieving supply chain event information associated with the supply chain event from the external source system using the invoked web service;
validating the retrieved supply chain event information of the supply chain event; and
storing the supply chain event in an external source system format.

13. The computer-implemented method of claim 11, further comprising:
transforming the source document information into an internal format.

14. The computer-implemented method of claim 11, further comprising:
determining whether a supply chain financial orchestration flow is assigned to the source document; and
assigning a supply chain financial orchestration flow to the source document where it is determined that no supply chain financial orchestration flow is assigned to the source document.

15. The computer-implemented method of claim 11, further comprising:
defining a documentation and accounting rule that is associated with the supply chain financial orchestration flow, wherein the one or more tasks are defined for the documentation and accounting rule;
defining a transfer pricing rule that is associated with the supply chain financial orchestration flow, wherein the transfer pricing rule defines a rule to calculate a transfer price;
defining an agreement that is associated with the supply chain financial orchestration flow, wherein the documentation and accounting rule and the transfer pricing rule are defined for the agreement; and
defining the supply chain financial orchestration flow, wherein the supply chain financial orchestration flow comprises a business process type, a physical route, a financial route, a primary route, and a supplier ownership change event.

16. A system, comprising:
a supply chain event reception module configured to receive a supply chain event from an external source system;
a source document retrieval module configured to retrieve source document information associated with a source document referenced by the supply chain event;
a supply chain financial orchestration flow retrieval module configured to retrieve a supply chain financial orchestration flow assigned to the source document, wherein the supply chain financial orchestration flow defines a trade relationship between a first entity and a second entity;
a task selection module configured to select one or more tasks defined for the supply chain financial orchestration flow; and
an execution module configured to initiate execution of the one or more tasks, where each task is executed at an external target system.

17. The system of claim 16, further comprising:
a web service invocation module configured to invoke a web service of the external source system;
an information retrieval module configured to retrieve supply chain event information associated with the supply chain event from the external source system using the invoked web service;
an information validation module configured to validate the retrieved supply chain event information of the supply chain event; and
an event storage module configured to store the supply chain event in an external source system format.

18. The system of claim 16, further comprising:
a transformation module configured to transform the source document information into an internal format.

19. The system of claim 16, further comprising:
a determination module configured to determine whether a supply chain financial orchestration flow is assigned to the source document; and
an assignment module configured to assign a supply chain financial orchestration flow to the source document where it is determined that no supply chain financial orchestration flow is assigned to the source document.

20. The system of claim 16, further comprising:
a documentation and accounting rule definition module configured to define a documentation and accounting rule that is associated with the supply chain financial orchestration flow, wherein the one or more tasks are defined for the documentation and accounting rule;
a transfer price definition module configured to define a transfer pricing rule that is associated with the supply chain financial orchestration flow, wherein the transfer pricing rule defines a rule to calculate a transfer price;
an agreement definition module configured to define an agreement that is associated with the supply chain financial orchestration flow, wherein the documentation and accounting rule and the transfer pricing rule are defined for the agreement; and
a supply chain financial orchestration flow definition module configured to define the supply chain financial orchestration flow, wherein the supply chain financial orchestration flow comprises a business process type, a physical route, a financial route, a primary route, and a supplier ownership change event.
